(19) United States
(12) Patent Application Publication
(10) Pub. No.: US 2002/0041328 A1
(43) Pub. Date: Apr. 11, 2002

(54) Direct broadcast imaging satellite system apparatus and method for providing real-time, continuous monitoring of earth from geostationary earth orbit and related services

(75) Inventors: Malcolm LeCompte, Westford, MA (US); Michael Hewins, Belvedere, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AstroVision International, Inc., Gaithersburg, MD (US)

(21) Appl. No.: 09/820,347

(22) Filed: Mar. 29, 2001

Related U.S. Application Data
(60) Provisional application No. 60/192,893, filed on Mar. 29, 2000.
(60) Provisional application No. 60/205,155, filed on May 18, 2000.
(60) Provisional application No. 60/218,683, filed on Jul. 17, 2000.

(51) Int. Cl. H04N 7/18; H04N 9/47

(52) U.S. Cl. 348/144

(57) ABSTRACT

A system, method and apparatus for collecting an distributing real-time, high resolution images of the Earth from GEO include an electro-optical sensor based on multi-megapixel two-dimensional charge coupled device (CCD) arrays mounted on a geostationary platform. At least four, three-axis stabilized satellites in Geostationary Earth orbit (GEO) provide worldwide coverage, excluding the poles. Image data that is collected at approximately 1 frame/sec, is broadcast over high-capacity communication links (roughly 15 MHz bandwidth) providing real-time global coverage of the Earth at sub-kilometer resolutions directly to end users. This data may be distributed globally from each satellite through a system of space and ground telecommunication links. Each satellite carries at least two electro-optical imaging systems that operate at visible wavelengths so as to provide uninterrupted views of the Earth's full disk and coverage at sub-kilometer spatial resolutions of most or selected portions of the Earth's surface.

### CROSS-REFERENCE TO RELATED PATENT DOCUMENTS

The present document contains subject matter related to that described in co-pending U.S. patent application Ser. No. 09/344,358, filed Jun. 25, 1999, entitled “Direct Broadcast Imaging Satellite System Apparatus and Method for Providing Real-Time, Continuous Monitoring of Earth From Geostationary Earth Orbit”; U.S. provisional patent application Ser. No. 60/192,893, filed Mar. 29, 2000, entitled “Direct Broadcast Imaging Satellite System Apparatus and Method for Providing Real-Time, Continuous Monitoring of Earth From Geostationary Earth Orbit”; U.S. Provisional Patent Application Ser. No. 60/205,155, entitled “Direct Broadcast Imaging Satellite System Apparatus and Method for Providing Real-Time, Continuous Monitoring of Earth From Geostationary Earth Orbit and Related Services” filed May 18, 2000; and U.S. Provisional Patent Application Ser. No. 60/218,683, entitled “Direct Broadcast Imaging Satellite System Providing Real-Time, Continuous Monitoring of Earth From Geostationary Earth Orbit and Related Services”, filed Jul. 17, 2000 the entire contents of each of which being incorporated herein by reference. The present document also claims the benefit of the earlier filing date of the above-identified U.S. Provisional Patent Applications, Ser. Nos. 60/192,893, 60/205,155, and 60/218,683.

### BACKGROUND OF THE INVENTION

1. Field of the Invention:

The present invention relates to methods, systems and services for making global observations of the Earth at sub-kilometer spatial resolutions in real-time, where real-time refers to a delay of not more than two minutes total for creating, refreshing and distributing each image. More particularly, the present invention is directed towards methods, apparatuses and systems that provide real-time coverage of at least 70% of the observable Earth surface at a spatial resolution of less than 1 kilometer. The present invention also relates to weather-warning systems, and other warning systems associated with optically visible information obtained from Earth and Near Earth observations that monitor short and long-term changes in atmospheric, land and marine environments, induced by natural or human causes and impacting all facets of human society. Specific innovative applications for the data and service are cited including land and marine agriculture and natural resource management, national security, and a broad spectrum of human leisure and work related activities such as entertainment and transportation (traffic) management.

2. Discussion of the Background

Over the last 30 years, since the first weather monitoring satellite was placed in geostationary earth orbit (GEO), various satellite systems have been used to monitor features of the Earth. The reason is that at GEO the relative motion of the Earth and the satellite is nulled, providing a constant perspective of the Earth's surface from 35,800 km above the Earth's equatorial plane. Accordingly, images taken of the portion of the Earth's surface and atmosphere that fall within the footprint of the satellite (a cone intersecting the Earth between 81° North and South Latitude) will record only changes in the scene viewed against a fixed background surface area.

In the Western hemisphere, weather forecasting methods rely heavily on data supplied by the Geostationary Operational Environmental Satellites (GOES) series, operated by the National Oceanic and Atmospheric Administration (NOAA). The GOES series was developed from the prototype “Advanced Technology Systems” 1 and 3 (ATS-1, -3) launched in 1966 and 1967, respectively. These and all subsequent systems have been implemented with scanning imaging systems that are able to produce full disk images of the Earth at 1 km resolution in about 20-30 minutes.

The newest of the GOES satellites (8, 9 and 10) are 3-axis stabilized and are configured to observe the Earth at 1 panchromatic visible and 4 infrared wavelengths per satellite. The visible imaging systems use a “flying spot” scanning technique when a mirror moving in two axes, East-West and North-South, scans a small vertically oriented 8 pixel element of the fully viewable scene (the instrument's full area of regard) across an array of eight vertically arranged silicon pixels. The individual pixel field of view is about 28 microradians. Each scene element is sampled for just under 50 microseconds with a scan across the earth's disk requiring about 20 seconds to complete. In order to support this slow scanning method, the GOES satellite payload stability must be extraordinarily high so that almost no relative movement occurs between any one scan line of the samples. Accordingly, the payload pointing does not nominally deviate further than ⅓ of a pixel during an entire, 1 second duration scan. Because there are over 1,300 scan lines to create a full disk image it takes over 22 minutes to create the full image. The GOES system can be commanded to limit the extent of the region scanned exchanging full disk coverage for more frequent observations of a smaller region. Operationally, full disk sampling is actually performed once every three hours, to allow more frequent sampling of the either the Northern Hemisphere or mid-latitudes North and South of the Equator; providing gray-scale and infrared images at between 15 and 30 minute intervals for each area respectively. Limited regions may be sampled as frequently as about once per minute, during “super rapid scan operations” (SRSO). In practice, SRSO operations are rarely used because coverage of larger areas is too important to be neglected for long periods of time. Moreover, significant Earth-based events that occur during lapses in coverage of a particular region may be missed. In other words, satellite sensors may be looking at an uneventful portion of the Earth's surface when the significant activity is occurring at another location. Furthermore, as recognized by the present inventor, phenomena that may occur at night may only be seen in the infrared channels, if at all. The infrared channels also have a much coarser spatial resolution than the visible channel and otherwise are subject to the same limitations inherent in a scanning system.

GOES satellites provide a system that is optimized for monitoring cloud motion, but is far less suitable for observing other geophysical events. At visible wavelengths, clouds are efficient diffuse mirrors of solar radiation and therefore appear white with variations of brightness seen as shades of gray. Color, enhancing the contrast and visibility of the Earth's surface background, may actually detract from cloud visibility in a scene. Moreover, adding color may triple the amount of information and thus digital storage and broadcast capacity required of an image, which increase cost, physical size and telemetry bandwidth for a satellite system. Furthermore, observations of significant, but perhaps transient phenomena that occur in time scales of seconds or minutes (such as violent weather events, volcanoes, lightning strikes or meteors) may be late or not observed at all. Accordingly, the information provided from systems like the GOES system is unable to provide a “watchdog” service at high temporal and spatial resolutions that reliably report real-time information over a significant portion of the Earth's surface. Also, “video” style loops created from successive images having relatively coarse temporal resolution may lack the continuity needed to provide truly reliable information if cloud movements between image samples are much greater than a pixel dimension. The temporal coherence among the pixels of a scanned image and between the co-registered pixels of successive images will degrade as the time required to create the image and the elapsed time interval between scans increases. These effects have a significant adverse impact on the fidelity of any “image” created to represent the state of the Earth at a given moment, but particularly harmful to attempts to build animations using successive co-registered scanned images of a given area.

Referring to FIG. 1, coverage areas are shown for various weather satellites in addition to the GOES satellites. The GMS-5, parked at 140° East longitude, is a Japanese weather satellite showing a coverage area that includes the South-East Asia and Australian areas of the world. The Chinese FY (Feng-Yun) satellite is parked at 104° East longitude and shows a substantially overlapping coverage area with the GMS-5 satellite. The European space agency's METEOSTAT-7 satellite, parked in a 0° orbit, requires a license to decrypt and thus limits distribution for three days after observation. In contrast, the GOES, GMS and FY satellites have open reception and distribution via NASA-funded Internet links. Other satellites that perform similar operation include the Indian INSAT-1D, which is parked at 83° East Longitude, and the Russian system, GOMS/ELECTRO, which is not currently operational. A common feature of these different satellite systems is that they employ a spin scan or scanning visible imaging systems that require from 25 minutes to three hours to acquire a full disk image of the Earth. Furthermore, each system records visible imagery at a variety of spatial resolutions, all poorer than GOES which provides 1 km at the Nadir point.

There have been a number of proposals made in the past by various individuals and groups to place a camera on a large commercial communication satellite positioned in GEO. In each case, the camera would operate as a parasitic device, in that the camera would use the power and communication sub-system of the satellite to support its operational requirements. The most recent and most detailed examples, were made by Hughes Information Technology Corporation, a former subsidiary of Hughes Aircraft Company and the MITRE Corporation. These examples are discussed below.

The Hughes Proposal was described under various names such as “EarthCam”, “StormCam”, and “GEM” (Geostationary Earth Monitor) and involved a television style imaging system using a two dimensional charge coupled device (CCD) detector array to create an image of 756 pixels wide by 484 pixels high at intervals that range from between two minutes to eight minutes. The frame rate for this TV-style camera was determined by compression limitations in the satellite's meager 1-5 Kbps housekeeping data channel capacity. The Hughes Proposal described placing a digital camera on board one or more of Hughes' commercial telecommunication satellites (COMSAT). This parasitic camera was to operate using power provided by the COMSAT and deliver data to a Hughes ground operation center by way of a very low data rate housekeeping telemetry link. Data was then to be distributed to various users from this single command and control facility.

The system proposed employing cameras placed on board the Hughes satellites to be located at 71° West, 101° West, 30° East and 305° East longitudes. Upon receipt, and after processing, data would be distributed via land line or communication satellite links to end-users. The single visible imaging system would operate with a zoom mode so as to achieve approximately 1 km spatial resolution while building a composite hemispheric view from lower resolution images.

As presently recognized, the system proposed by Hughes was deficient in both its camera resources and communication systems infrastructure with regard to the following three attributes. The system proposed by Hughes did not provide real-time images (as defined herein) as a result of the delay between frames. Another deficiency was that real-time images cannot be distributed in real-time, due to the interval between frames and the slow data rate, as well as the single point data reception and distribution facility. Furthermore, the system proposed by Hughes was deficient in its inability to provide hemispheric (full disk images) in real-time. This limitation is due to the limited telemetry channel capacity, limited camera design and the time required to create a composite full disk image. Accordingly, as is presently recognized, the system proposed by Hughes neither appreciated the significance of providing an infrastructure that would be able to provide real-time images, distribute the real-time images, and provide for the compilation of a composite full disk images in real-time.

In 1995, the MITRE Corporation published a study that was performed in 1993. The study examined the use of parasitic instruments on commercial communications satellites for the dual purpose of augmenting government weather satellites and providing a mechanism for low cost test and development of advanced government environmental monitoring systems. The study performed by MITRE examined in some detail the application of newly developed megapixel, two-dimensional, CCD arrays to geostationary imaging systems. The study concluded that considerable gains in capacity could be achieved using the CCD arrays. Although the advent of CCD arrays as large as 4096×4096 were anticipated at the time the study was performed, the authors recognized that an array of 1024×1024 was the largest practical size available for application at that time.

Two distinct types of CCD array applications were considered, time-delay integration (TDI) and “step-stare” as alternatives to the traditional “spin-scan”, or “flying-spot” imaging techniques. The TDI approach can be viewed as a modification of the “flying-spot” in that it uses an asymmetrical two-dimensional array, e.g., 128×1024, oriented with the long axis vertical so as to reduce the number of East-West scans. In this technique, every geographic scene element is sampled 128 times, which increases the signal-to-noise level. However, communication satellites are relatively unstable platforms. With a single pixel integration time on the order to milliseconds, spacecraft movement during the accumulation of over 100 samples may degrade the spatial resolution within any scene element. This effect, which is in addition to the navigation and registration degradation due to scan line shift, is called “pixel spread”. Image spread over long integration periods also degrades or precludes low illumination or night observing at visible wavelengths.

The “step-stare” approach was identified in the MITRE study as being the preferred technique. A large, two-dimensional CCD array in this technique is used to capture a portion of the image of the Earth. The optical pointing is incrementally “stepped” across the face of the Earth by an amount nearly equal to its field of regard at each step. The overlap ensures navigational continuity and registration correctness. With reasonable, but not extraordinary satellite stability, the frame time may be increased to milliseconds so as to achieve required levels of sensitivity without compromising navigational or registration criteria or image quality.

The MITRE study proposes the use of sub-megapixel arrays (1024×512). With a dwell time per frame of approximately 150 milliseconds, an entire composite full Earth disk image at 500 meter spatial resolution could be created from a mosaic of nearly 1,200 frames in relatively few minutes. The maximum exposure time to create an image in daylight is much shorter than 150 milliseconds for most CCD arrays. Furthermore, a reasonably stable satellite undergoes little motion during such a brief time interval thus reducing pixel spread. In order to ensure coverage of the entire Earth's surface, frames are overlapped by an amount defined by the satellite stability. This step-stare technique steps the frames in North-South or West-East lines, simultaneously exposing all pixels in an array. This ensures accurate registration and navigation of image pixels.

According to the MITRE study, the time between frames in a 500 meter resolution mosaic image of the Earth is three minutes (equal to the time needed to create the mosaic). As presently recognized, during this three minute interval, the motion of objects observed, such as clouds and smoke plumes, will cause the object's apparent shape to change in a discontinuous fashion. The continuity of successive observations will thus be compromised and degrade “seamless” coverage by an amount proportional to the velocities of the objects causing the shapes to apparently change. This degradation is called image smear and becomes more apparent as the time between frames increases, thus putting a premium on decreasing the time to create a mosaic of the full disk image.

As presently recognized, with sufficient stability, it is possible for a CCD imaging system to allow the shutter to remain open to collect more light to enhance low illumination performance. This specific impact of CCD arrays in a step-stare scan on night imaging is not noted in the MITRE study. As recognized by the present inventor, low illumination imaging is possible by reducing the stepping rate, and allowing the camera field to dwell on the area of regard for a predetermined amount of time while integrating its emitted light. At the time of the MITRE study, time exposures to achieve night imaging capability would have increased the time to acquire a full disk image of the Earth to about 24 minutes, or about the same amount of time as the flying spot technique. Furthermore, the significance of obtaining real-time night images or the mechanisms needed to obtain the images was never appreciated, and thus not realized. In the MITRE study, data distribution was accomplished either by embedding a low data rate in the spacecraft telemetry, or directly to receive sites by preempting the use of one of the satellite's transponders. While the emphasis was on rapid full disk imaging, no special considerations were given to disseminate the data either live or globally.

In 1995, the Goddard Space Flight Center announced a study called the “GEO Synchronous Advanced Technology Environmental System” (GATES) that was expected to lead the development of a small satellite system equipped with a “push broom” scanning linear CCD array imaging device. This system was to use motion induced by the satellite's attitude control system to make successive scans of the visible Earth's disk. The satellite's attitude control momentum wheels would be used to slew the entire system back and forth 12 times while the field of regard of the camera's linear array is stepped from North to South to achieve a full disk scan in about 10 minutes. This system uses a 1,024 pixel long one-dimensional linear CCD array “flying spot” similar to, but much longer than, the GOES' eight pixel array.

As presently recognized, limitation with the GATES system is that live images are not possible, nor is night imaging. Data was distributed from a single receive site, via the Internet. A limitation with the Hughes proposed system, the MITRE system, and the GATES system, is that none of the systems appreciate the interrelationship between providing a real-time continuous monitoring capability of the entire Earth that is accessible from a geostationary Earth orbit, while providing high resolution images. In part, the limitation with all of the devices is that none of the devices would be able to reliably provide the “watchdog” high resolution imaging function that would provide a remote user with valuable real-time data of dynamic situations occurring at or near the Earth's surface.

Conventional High Resolution Imaging Systems

A summary of state of the art optical sensing from space now follows and will include examples from both low earth orbiting (LEO) remote sensing systems looking at the Earth and space based astronomical observatories.

DMSP

The U.S. Military's Defense Meteorology Satellite Program (DMSP) operates two satellite weather systems in polar, sun synchronous (equatorial crossing at 0600 and 1100), orbits at an altitude of 840 km, provides multispectral imagery of the Earth's surface at spatial resolutions of:

One Panchromatic Band at 550 meters

One Thermal IR Band at 2,700 kilometers.

Other relevant satellite-platform characteristics are:

Image total area footprint: 3000 km swath

3-Axis Stabilization with reaction wheels and torque rods plus star sensors for pointing accuracy of 0.01 degrees.

System Mass: 770 kg.

S-Band Data Link with Band Width: 5 MHz or 5 Mbps

LANDSAT-7

The NASA LANDSAT-7 is an earth remote sensing system in a polar, sun synchronous (equatorial crossing at 1000), orbit at an altitude 705 km, provides multispectral imagery of the Earth's surface at spatial resolutions of:

One Panchromatic Band at 15 meters

Multispectral (Six Visible and near IR Bands) at 30 meters

One Thermal IR Band at 60 meters

Other relevant satellite-platform characteristics are:

Image total area footprint: 183×170 km

3-Axis Stabilization with reaction wheels and torque rods with pointing accuracy of 0.015 degrees.

System Mass: 2,200 kg.

X-Band Data Link with Band Width: 300 MHz or 300 Mbps

Commercial remote sensing systems that have been or are being orbited in the near future are generally similar with regard to spatial and temporal resolution to these two systems. For example, SeaWiFS is similar in some regards to the DMSP system and Space Imaging's IKONOS is somewhat similar to LANDSAT-7.

If one of these systems were moved to GEO, the spatial resolution performance would be insufficient for 10 m resolutions. The difference between the spatial resolution capabilities of these systems is due almost entirely to the approximately 50:1 difference in their respective orbital altitudes. However, none of the LEO systems operate in a manner that would allow them to provide hyper-temporal resolution imagery of the earth's surface. That capability requires a scanning mechanism to compile a mosaic of the Earth's full disk.

DSP

The U.S. Military's Defense Support Program (DSP) operates a satellite Optical (Infrared) Early Warning System in GEO providing infrared imagery of the Earth at unknown spatial resolution. However, the primary instrument operates by coupling a 3.6 meter diameter Schmidt telescope with the spacecraft 6 rpm spin to build an image using a 6,000 element IR detector array. Image revisit frequency is potentially 6 times per minute. The resolution of this system can be bounded by assuming the system operates at either 1 micron or 10 microns

With a scanning imaging system operating in a near IR band (1.0 micron), its maximum theoretical spatial resolution would be no better than: 0.278 urads, or about 10 meters. In this case, a 6,000 array imaging system would have a swath width of 60 km. With a raster scanning system, a full disk image could be created no more frequently than every 35 minutes.

With a scanning imaging system operating in a thermal IR band (10.0 micron) its resolution will be no better than: 2.78 urads, or about 100 meters. In this case, a 6,000 array imaging system would have a swath width of 600 km. With a raster scanning system, a full disk image could be created no more frequently than every 3.5 minutes.

Other relevant satellite-platform characteristics are:

Image total area footprint: see above

Spin Stabilization: Zero momentum stabilized using a reaction wheel to counter the spacecraft 6 RPM spin.

System Mass: 2386 kg.

Data Link Band and Capacity unknown

Although the DSP system may constitute a hyper-spatial imaging capability, particularly if operating at optical wavelengths, it really offers no improvement in temporal resolution over the GOES system. Operating as a thermal IR sensor, it may achieve hyper-resolution performance, but the wavelength regime sampled has little relevance to Earth surface sensing applications which require observing in optically visible or near IR bands. For imaging at optical wavelengths, the DSP system lacks the advantage of multi-megapixel CCD arrays, and a stable, staring platform.

Hubble Space Telescope (HST)

The Hubble Space Telescope is a large astronomical observing system operating at optical wavelengths. It occupies an equatorial orbit, 590 km altitude at an inclination of 28°. In terms of pointing accuracy and spatial resolution, HST defines the state of the art.

Wide Field Planetary Camera 2 (WFPC2) Wide Mode: 17 meters

Wide Field Planetary Camera 2 (WFPC2) Narrow Mode: 8 meters

Other relevant satellite-platform characteristics are:

Image total area footprint: 27.2×27.2 km Wide Mode

Image total area footprint: 6.4×6.4 km Narrow Mode

3-Axis stabilized, zero momentum biased control system using reaction wheels with a pointing accuracy of 0.007 arc-sec. Rate gyros are the guidance sensors for large maneuvers and high-frequency (>1 Hz) pointing control. At lower frequencies, the optical Fine Guidance Sensors (FGSs) provide for pointing stability. (0.007 arc-sec=1.9(−6)°=34 nanoradians)

System Mass: 10,863 kg.

S-Band Data Link with Band Width: 512 KHz or 512 Kbps

However, the HST is equipped with optics configured to observe celestial bodies and not for earth imaging. The telescope for HST is directed towards space and not the earth. Thus, hyper-spatial imaging of the earth's surface is neither contemplated nor employed with the Hubble Space Telescope.

### SUMMARY OF THE INVENTION

The following is a brief summary of selected attributes of the present invention, and should not be construed as a complete compilation of all the attributes of the inventive system, apparatus and method. The section entitled “Detailed Description of the Preferred Embodiments”, when taken in combination with the appended figures, will provide a more complete explanation of the present invention.

One object of the present invention is to provide a method, system and apparatus for real-time collection of hemispherical scale images at sub-kilometer resolution from around the Earth and for distributing the images to users located anywhere on the Earth.

Another object is to provide real-time, continuous image collection at electro-optical (primarily visible, but also infrared and ultraviolet) wavelengths, including color information.

A further object is to provide real-time coverage of the entire viewable Earth from geostationary orbital platforms at sub-kilometer resolutions, while combining full disk and/or global composite images.

Still a further object of the present invention is to provide real-time global distribution of the real-time full disk and/or composite global view, which includes nighttime imaging.

Yet a further object of the invention is to provide live coverage of geophysical phenomena at geostationary observation levels based on high spatial and temporal resolution cameras that would also be able to observe features related to, or due to, human activities on the planet, including city lights at night, large fires, space shuttle launch and re-entry, movement of large maritime vessels, contrails of aircraft and large explosions, for example.

Still a further object of the invention is to provide an ability to seamlessly monitor events from geostationary orbit with a rapid framing system, where such events include the daily movement of large storm systems, migration of the day/night terminator, night side lightening, major forest fires volcanic eruptions, seasonal color changes, bimonthly transits of the moon, solar eclipses, and the Earth's daily bombardment by large meteors.

Another object of the invention is to provide a hyper-resolution mode of operation, where either the entire visible Earth's surface if scanned, or selected regions are scanned for providing 10 m or less resolution. Such high-resolution data is available for use in land and marine agricultural and resource management applications by identifying real time crop or feed stock health and location. Transportation applications include identifying maritime and land environmental information and air, sea and land vehicle observable signatures, thereby forming an information source for a wireless traffic management and rerouting service.

Another object of the present invention is to provide a real-time weather data collection service that analyzes and distributes real-time information to end users who can benefit from the availability of such real-time information. In one embodiment of the present invention a central service is made available for providing real-time data regarding weather-related effects as the weather effects relate to commodities exchanging. In another embodiment, data regarding transportation routes and the availability of particular routes as being subject to particular weather disturbances is provided. In another embodiment of the invention, data from the weather service is provided to assist in re-allocation of utilities (such as electric utility) so as to efficiently distribute loads to avoid weather-related events. In another embodiment, the use of the data stream is made available to insurance providers and local authorities so as to warn residents to protect themselves and property thus minimizing the effect of weather on the ultimate insurance claims for a particular area. Subsequently, the data may also be available to assist an insurance company, for example, in the allocation of resources when assessing damages as a result of the weather activity. In another embodiment of the present invention the real-time weather data is analyzed at a central facility and used for rerouting airline traffic and even airport traffic as a function of the weather. In still another embodiment of the present invention, the temporal aspect of worldwide weather coverage is made available as an input parameter to weather models. In this way, the accuracy and responsiveness of the weather model to the real-time data is more accurate than traditional methods that are not based on rate of change data for considering time as being a parameter of the weather model.

The above and other objects are accomplished with a system that includes electro-optical sensors based on multi-megapixel two-dimensional charge coupled device (CCD) arrays mounted on a geostationary platform. In particular, the CCD arrays are mounted on each element of a constellation of at least four, three-axis stabilized satellites in geostationary Earth orbit (GEO). Image data that is collected at approximately 1 frame/sec, is broadcast over high-capacity communication links (roughly 15 MHz bandwidth per camera) providing real-time global coverage of the Earth at sub-kilometer resolutions directly to end users. This data may be distributed globally from each satellite through a system of space and ground telecommunication links. Each satellite carries multiple two electro-optical imaging systems that operating at visible wavelengths so as to provide uninterrupted views of the Earth's full disk and coverage at sub-kilometer spatial resolutions of most or selected portions of the Earth's surface. The same GEO satellites may also accommodate ultraviolet and infrared sensors to augment the visible imaging system data. The sensors on each satellite provide continuous real-time (e.g., at least 1 frame/sec, with preferably not more than a 2 minute lag time until the data reaches the end user) imagery of the entire Earth accessible surface from each satellite's GEO location, around the clock, at a variety of spatial, spectral and temporal resolutions so as to ensure uninterrupted coverage.

The designated field of view of each visible light imaging system on a given satellite progresses from larger to smaller as the spatial resolution offered increased from coarse to fine. The widest field of view provided by each 2-D CCD imaging system is fixed and encompasses the entire full disk of the Earth as seen from GEO (17.3°). Other imaging systems are free to point and dwell or scan within the area of regard of the widest field of use system. Step-stare scanning is accomplished to create a hemispheric scale mosaic image of the Earth's full disk in real-time at the highest possible spatial resolution while ensuring the most accurate image navigation and registration possible. Each satellite includes at least one of an X-band and/or KA-band communications transponder that illuminates a footprint that allows the data to be broadcast directly to end users anywhere within the line of sight of the satellites. The antenna may either be a parabolic dish, or a phased array antenna that provides single beam or multibeam coverage.

The real-time data is distributed beyond the satellite's “line-of-sight” using leased transponder bandwidth on a network of at least three commercial communications satellites, a cross-linked connection between imaging satellites, or even a terrestrial based data routing network, or a hybrid between the space-based and terrestrial-based communication assets.

Another object of the present invention is to use a high temporal resolution, hyper-spatial resolution (less than 100 m resolution at nadir, and more typically less than 10 m resolution) space-based system to provide imaging information regarding specific terrestrial features, events or processes and used by information disseminating services on Earth. One such service is a traffic-management information service which provides information to land, sea and air vehicle owners and operators regarding environmental conditions, optimal routing, vehicle tracking, and even the level of congestion (visibility conditions permitting) on transportation pathways (roads, airways and sealanes).

Applications to traffic management are highly dependent on spatial resolution. At coarse spatial resolutions, the primary focus of the proposed GEO Earth monitoring system is to collect live data on environmental conditions that impact all types of transportation. However even at coarse resolutions, under the right environmental conditions, there will be opportunities to observe individual air, land and sea vehicles due to their impact on the medium through which they travel. Auto traffic over unpaved roads may leave dust clouds, aircraft leave highly visible contrails and ships create large wakes to mark their passage. As spatial resolution increases, the individual vehicles become detectable and live tracking of their positions and local pathway conditions becomes a real possibility.

In the hyper-spatial resolution configuration the GEO satellite is employed to detect individual vehicles, observe pathway conditions and relative amounts of traffic on any given transportation artery within the satellite optical field of view. The imaging may either be done in a real-time manner for selected areas, or also by way of a scanning operation, with perhaps less resolution than an on-demand directed service.

Another feature of the present invention is to provide a weather warning system through electronic media such as e-mail or interactive Internet. When specific weather events occur in particular geographic regions, subscribers to a service for processing the optical information collected in space will receive an electronic alert or e-mail message produced from a control center that receives satellite information directly from the imaging satellite.

An alternative service enabled by the real-time space-based imaging system is to provide a weather data and traffic management service to Maritime subscribers. The information is either broadcast directly from the satellite or also by way of an immediate broadcast source such as a terrestrial broadcast or a LEO-based communication service.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a weather satellite coverage chart of several conventional satellites;

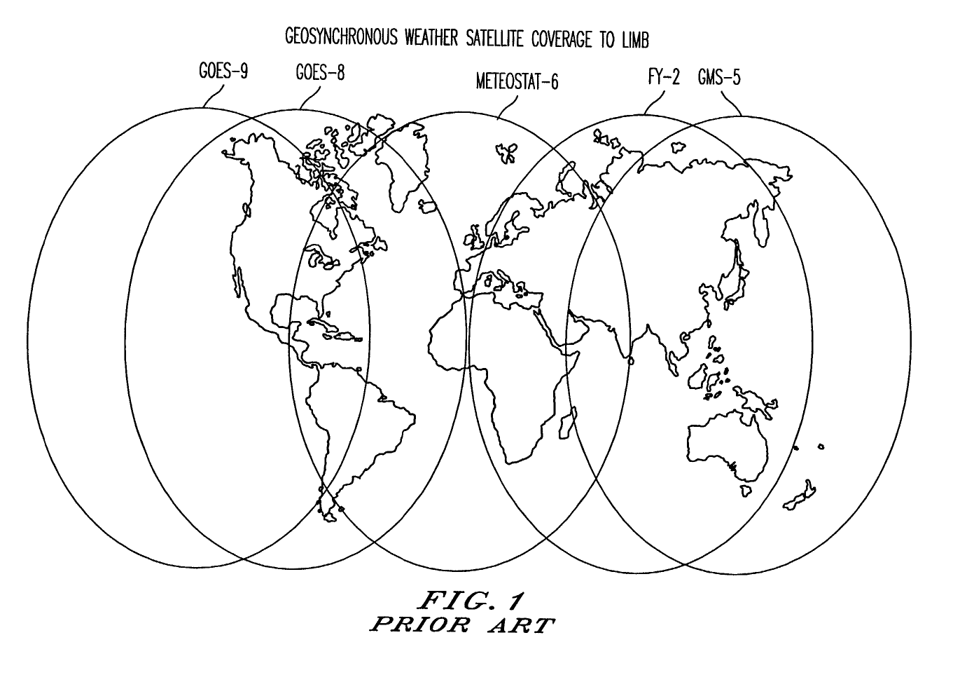

FIG. 2 is an illustration of component images of a step-stare operation of the first seven images of a scan sequence as well as a composite image of the seven images;

FIG. 3 is an illustration of a geostationary-based real-time high resolution imaging and data distribution system according to the present invention;

FIG. 4 is a block diagram of system components employed on the image processing portion of the GEO satellite according to the present invention;

FIG. 5 is a constellation position diagram showing a four-satellite constellation and three satellite communication segment according to the present invention;

FIG. 6 is similar to FIG. 5, but includes five imaging satellites;

FIG. 7 is a chart showing the amount of Fractional Earth Coverage vs. Nadir Resolution for 3-satellite, 4-satellite, and 5 satellite constellations according to the present invention;

FIG. 8 is an exploded diagram of components of the imaging satellite according to the present invention;

FIG. 9 is a block diagram of components included in a controller hosted on the geostationary imaging satellite according to the present invention;

FIGS. 10a, 10b and 10c are overhead views of highways with varying degrees of traffic congestion as viewed by a GEO satellite with hyper-spatial resolution;

FIG. 11 is a block diagram of a ground terminal that receives information from the satellite and provides information services based on the information provided from the satellite;

FIG. 12 is a flowchart of a process for producing transportation management (including environmental conditions and traffic congestion) information for distribution to navigation systems and motorists;

FIG. 13 is a data structure for reporting transportation management (including environmental conditions and traffic congestion) information as observed from a GEO stationary satellite with hyper-spatial resolution capabilities;

FIG. 14 is a flowchart of a process for receiving and employing information regarding transportation management (including environmental information and traffic congestion) for efficient route planning; and

FIG. 15 is a flowchart of a Maritime and ground-based weather alert information distribution and warning system.

FIG. 16 is a flowchart showing how data according to the present invention may be employed by a central interpretation service that provides data regarding the trading of commodities in a real-time fashion;

FIG. 17 is a flowchart describing how weather related data extracted according to the present invention may be used to provide information for rerouting different transportation routes for airlines, shipping, trucking, and ocean cargo ships for example;

FIG. 18 is a flowchart of a process employed by the present invention for minimizing insurance related risks by predicting and avoiding natural disaster events and subsequently assessing damages caused by such events; and

FIG. 19 is a flowchart showing how the present invention is employed to redistribute and reallocate power in a utilities industry, such as an electric utility.

### DESCRIPTION OF THE PREFERRED EMBODIMENTS

Over the past 40 years since the first Sputniks and 30 years after the first weather monitoring satellite was placed in GEO, exploration of the Earth from space remains incomplete and inadequate. As of yet, there exists insufficient mechanisms to observe and study all of the processes that occur day or night and on or near the Earth's surface that may influence life on our planet. Furthermore, there is presently no capability to monitor the entire surface in real-time as a global system and to distribute that data to all parts of the Earth in real-time. The present method, apparatus and system described herein is aimed to provide a comprehensive, simultaneous and real-time observation platform of the Earth's global environment and offer the information gathered from that perspective to a global audience. Accordingly, the coverage is made at temporal and spatial scales and resolutions configured to capture events on Earth that may possibly change over relatively short periods of time and be observable by appropriate electrical-optical sensors configured to mimic the human eye.

A feature of the present invention is to take advantage of the inherent processing capability of the human body, and in particular the human eye coupled with the processing power of the human brain. The human eye is an extremely effective research tool and components employed in the present invention exploit the spectral, spatial, temporal and radiometric attributes that are readily processed by the human eye coupled with the human brain. In particular, attributes of the human eye that are relevant to being the ultimate “detector” of image information include the following:

the human eye is accustomed to making observations in real-time;

the human eye continually refreshes imaged scenes;

the human eye requires similar time scales to both collect and process images;

the human eye provides simultaneous multi spectral (color) coverage of the surrounding environment; and

the human eye automatically adjusts to a wide range of varying (diurnal) light levels, gracefully degrading its performance to continue providing valuable information within approximately the same spectral region.

The fact that instruments currently monitoring the Earth's environment are much less capable than the human eye in these respects, ensure that there will be gaps in an observer's ability to observe many important phenomena that occur on or near the Earth's surface, as detected from a space-based sensor. Multi-spectral coverage of the Earth at visible wavelengths during the day, and with sufficient sensitivity to observe phenomena on the Earth at night is rare. In such rare instances, the observation platform is made on low Earth orbiting (LEO) satellites, where it is impossible to develop a full disk, hemispheric or global perspective of the Earth, but only in a scanned sense. Thus, platforms based too close to the Earth fail to exploit the attributes of the human eye and the human brain, which are quickly able to process images that cover an entire scene, including the full disk of the Earth, provided that the data provided to the eye is presented in a way that preserves the true dynamics of the thing being observed and not on an artificial time-scale in which significant time gaps are present between image frame. Providing the images in a discontinuous fashion where significant time gaps are present between frames would fail to capitalize on the processing power of the human eye and brain.

The present invention recognizes that by combining images taken from a GEO platform that remains fixed relative to a specific position on the Earth, avoids an inherent motion between the observed Earth surface, and the observing platform. Furthermore, the perspective offered from GEO allow for a “complete picture” of the Earth's surface to be captured so that the human brain may properly process the entirety of Earth-based events and the observable dynamics of the object being observed. Furthermore, providing the data in the form of images in a real-time fashion allows the coupling between the human eye and the human brain to operate in a seamless fashion and within a time frame that allows for the dissemination of warning signals for Earth inhabitants to take appropriate preventative measures, if necessary. Moreover, observations of the Earth are made from a GEO orbit because the vantage nulls all Earth-satellite differential irrelevant motion. Instruments on board the GEO satellite are able to monitor and record processes that occur on or near the Earth over long periods of time. The same scene is continually in view and may be sampled as frequently as desired.

Remote sensing of the environment is also useful from GEO because that location affords an observer the opportunity to see most of the hemisphere while the lack of relative motion provides a vantage from which to see processes unfold. Theoretically, from GEO, an imaging system can observe to within about 9° of a full hemisphere. However, foreshortening of the scene due to the Earth's spherical shape reduces the actual latitude regime that can be effectively monitored. The Northern-most point that is observable to a GEO satellite camera in an equatorial plane, lies at about 75° North latitude. However, in an alternative embodiment, one or more polar orbiting satellites may be used to augment the satellites described herein. One such orbit is highly elliptical with a 12 hour period, allowing it to “hang” over the poles for extended periods of time. Eight satellites in such a Molnyia orbit can make continuous, live observations of polar regions, although spatial resolution will vary as the satellite's altitude changes.

The GEO platform offers environmental monitoring that has an advantage of providing a “live” and continuous view of nearly an entire hemisphere. Satellite sensors at GEO have unrivaled opportunity to perform long-term observations of events occurring in virtually any portion of the viewable hemisphere. Transient phenomena such as volcanic eruptions, electrical storms, and meteors, as well as more slowly evolving events like floods, biomass burning, land cover changes are particularly good candidates for study and observation from a geostationary orbit, provided the images are refreshed and sent in real-time. Among the events that may be seamlessly recorded from a geostationary orbit by a rapid framing imaging system according to the present invention include the following events:

daily movement of major storm systems;

migration of the day/night terminator;

night-side lightening;

major forest fires;

volcanic eruptions;

seasonal color changes;

bimonthly limb transits of the moon;

solar eclipses; and

Earth's daily bombardment by large meteors.

In addition to live coverage of geophysical phenomena at a geostationary vantage point, using high spatial and temporal resolution cameras according to the present invention also enables the observation of features related to, or due to, human activities on the planet, including the following:

city lights at night;

large fires;

space shuttle launch and re-entry;

movement of large maritime vessels;

contrails of aircraft; and

large explosions.

In contrast to conventional systems that operate at LEO orbits for observing events on the Earth, the present invention deals with the problem of placing optical sensors much further away from the Earth at GEO, namely 36,000 km above the equator. At this distance, lower spatial resolution is employed to achieve hemispherical scale coverage at even moderate sampling frequencies. Because these GEO satellites are up to 100 times further from the Earth than LEO satellites, equivalent imaging system would provide roughly 10 meters of spatial resolution at LEO, while providing about 1 km at GEO.

Another problem that is addressed by the present invention is that the shear size of the Earth poses a problem for making real-time hemispherical scale observations at a kilometer scale (or better) spatial resolution. At GEO, 1 km at the Earth's equator subtends approximately 30 microradians. The full Earth itself is 17.3 (0.30 radians) in diameter. Monochromatic sampling of a visible hemisphere with sufficient resolution to discriminate features as small as a kilometer would require nearly one hundred million separate observations. Nearly half a billion samples would be required to produce the same image at 500 meter resolution. To deliver such a large image of the Earth to the ground requires a balance between data communications bandwidth, image production time and resampling frequency. For comparison purposes, a single two-dimensional NTSC television image is made of about 300,000 samples per scene in each of three colors at 30 such scenes per second, yielding a total of almost 10 million samples per second.

The result-effective variables addressed by the present invention, as presently recognized, include the following:

spatial resolution;

temporal resolution (i.e., resampling frequency); and

area coverage.

Until the recent advent of two-dimensional megapixel CCD arrays, space-based imaging systems fell broadly into two categories. The first category is two-dimensional vidicon-based systems (e.g., television) with low spatial but potentially high temporal resolution. The other imaging system included one-dimensional scanning systems with potentially high spatial (kilometer scale or worse), but low temporal (image resampling much less than every minute) resolution. As previously discussed, either one of such systems would fail to provide an adequate amount of information at reasonable refresh rates so as to provide the human eye and human brain with adequate information to definitively determine, track and assess events occurring at or near the Earth's surface.

Processes monitored from GEO are fundamentally transient in nature. Changes across an imaged area may involve either the evolution and migration of features across a scene, such as cloud movement, or the capture of events that materialize and occur within a scene, such as lightning. The former class of phenomena tend to evolve more slowly and are easily followed by scanning systems. The latter phenomena are more readily covered by the vidicon style.

Environmental monitoring from GEO has focused on cloud movements and characteristics due to imaging technology limitations and by the need to achieve good spatial resolution over a hemisphere scale area. Environmental monitoring systems rely on scanning systems with an implicit assumption that a cloud's shape will change more slowly than it will move across a scene.

Scenery sampling frequency is directly proportional to a cloud feature's velocity and inversely proportional to the observing instrument spatial resolution. The equation F=V/R helps explain this phenomena, where F is frequency, V is velocity and R is spatial resolution. For example, a cloud moving at (V=) 100 meters per second (330 kph or 220 mph), observed at a resolution of 1 km=1,000 m) need only be resampled once every 10 seconds (F=0.10/sec) to observe movement across one pixel from sample to sample. Clouds typically move at a tenth these speeds and a variety of factors including spacecraft pointing instability makes it difficult to discern movements smaller than a few pixels between samples.

For these reasons, imaging the Earth from GEO to discern lateral cloud group movements at spatial resolutions equal to, or coarser than 1 km does not require sub-minute temporal resolution. In practice, such sampling may be done a few times per hour or, at most, once per minute at a regional scale. Scanning systems in GEO have traditionally been used to achieve the most satisfactory compromise between image frequency, spatial resolution, area coverage and communication bandwidth. The systems have been equipped with a single element detector or a short linear CCD array mechanically scanned across the face of the Earth to slowly build an image. Such a system cannot make the “real-time”, seamless observations provided by the present invention due to the time required to build a two-dimensional image. Image frequency, however, may be reduced by the following factors, which are presently recognized as result effective variables:

increasing the speed of the scan (which reduces sensitivity);

increasing the length of the linear detector array (by adding more detectors); and

reducing the size of the area that is scanned.

In order to properly register each pixel relative to the geographic scene, and create a context for navigation within an image built from the scanning process, the spacecraft must be extremely stable. Otherwise, the scanning pixel(s) will “wander” somewhat during the scan and thus destroy the graphic integrity of the scene. Because scanning pixel systems must move the optically sensitive element across the scene, accumulating sufficient light to monitor processes at visible wavelengths is difficult during low-illumination conditions, at night and in real-time. Currently, observations of night city lights in one particular geographic location are only available at low spatial resolution, once a day, from the optical line scanning instrument aboard the low Earth polar orbiting defense meteorological satellite program (DMSP). However, such a system, does not provide the real-time, high resolution, geostationary images provided by the present invention.

The development of two-dimensional multi-megapixel arrays in recent years has for the first time made it possible for the creation of electro-optical systems that can provide real-time, around the clock coverage of the Earth's full disk as seen from GEO at unprecedented spatial resolution. According to the present invention, a constellation of at least four such GEO systems provides real-time coverage at sub-kilometer resolution over most of the viewable Earth. Each satellite provides a “live” broadcast in real-time to end users within the line of sight of each satellite.

As will be discussed, in order to augment the distribution capability for each satellite, leased commercial communication satellite transponders are employed to provide beyond line of sight communication to end users who are not in direct line of sight to the particular satellite that had the sensor for which the user is interested in viewing the images. Alternatively, each Earth observing satellite employs wideband down-link communication channels and cross-linked inter-satellite communication conduits so as to accomplish the distribution function without the use of additional communication pipelines.

As will be discussed herein, there are three distinct components to the method and apparatus described herein for real-time image collection around the Earth and subsequent data distribution of the collected images. The first component is a method, system and apparatus for creating and collecting real-time images. The second component is the imaging infrastructure that allows image coverage of the majority of the planet in real-time, seamless fashion at high-resolution. The third component is the distribution component, which is able to distribute the real-time images to the end users.

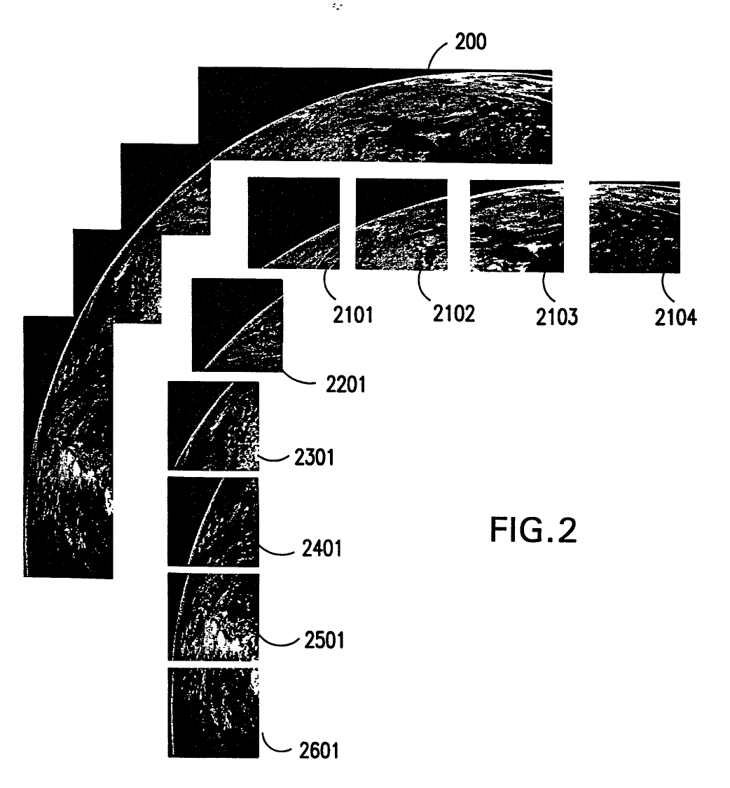

FIG. 2 shows a mosaic image of a portion of the Earth created by a step-stare scan technique implemented by the present invention. A full disk mosaic of the Earth may be built from individual frames, some of which are shown in FIG. 2. In FIG. 2, a first line of a mosaic scan image would start from East of the North Pole and would contain seven images moving from East to West. In FIG. 2, the first four images, of seven images, are shown as elements 2101, 2102, 2103, and 2104. The next row contains nine images, the first one of the row being identified as element 2201. Subsequently, the next row of images would contain 10 images in total, the first of which is denoted as 2310. The next five rows would each contain 11 images, the first of which in the first three rows of 11 images are denoted as 2401, 2501 and 2506. The five rows of 11 images are then followed by single rows of 10 images, 9 images and 7 images. This step-stare sequence is represented below where each image is denoted by a four digit code XX-YY. The first two digits (i.e., “XX”) represent the row number. The last two digits represent the sequence number of the image in a particular row. For example, 02-04 represents the fourth image of the second row.

01-01, 01-02, 01-03, 01-04, 01-05, 01-06, 01-07

02-01, 02-02, 02-03, 02-04, 02-05, 02-06, 02-07, 02-08, 02-09

03-01, 03-02, 03-03, 03-04, 03-05, 03-06, 03-07, 03-08, 03-09, 03-10

04-01, 04-02, 04-03, 04-04, 04-05, 04-06, 04-07, 04-08, 04-09, 04-10, 04-11

05-01, 05-02, 05-03, 05-04, 05-05, 05-06, 05-07, 05-08, 05-09, 05-10, 05-11

06-01, 06-02, 06-03, 06-04, 06-05, 06-06, 06-07, 06-08, 06-09, 06-10, 06-11

07-01, 07-02, 07-03, 07-04, 07-05, 07-06, 07-07, 07-08, 07-09, 07-10, 07-11

08-01, 08-02, 08-03, 08-04, 08-05, 08-06, 08-07, 08-08, 08-09, 08-10, 08-11

09-01, 09-02, 09-03, 09-04, 09-05, 09-06, 09-07, 09-08, 09-09, 09-10

10-01, 10-02,10-03,10-04,10-05,10-06,10-07,10-08, 10-09

11-01,11-02, 11-03,11-14,11-05,11-16, 11-07,

By tapering the number of images for the rows covering the Northern and Southern extremes of the Earth (i.e., rows 1-3 and 9-11) allows for the removal of 14 images than if a rectangular, 11×11 raster of 121 images were formed. In total, 107 image frames are accumulated and overlapped with one another so as to form a composite image 200 (which is only a portion of an image shown for demonstration purposes). These 107 frames are accumulated once per second so that events that change rapidly on or near Earth are surely captured and may be presented in a seamless fashion. The image data is captured at 11 bits per pixel and compressed to about 8 bits per pixel. The compressed data is then distributed on a broadband downlink channel (one of N channels, depending if the satellite transponder is also in charge of routing image data to a ground terminal from other imaging satellites). Each of the individual image frames overlap one another by about 10% of their pixel dimensions so as to accommodate satellite drift away from center pointing. An entire disk of the Earth may thus be recorded and transmitted to the ground in less than two minutes total.

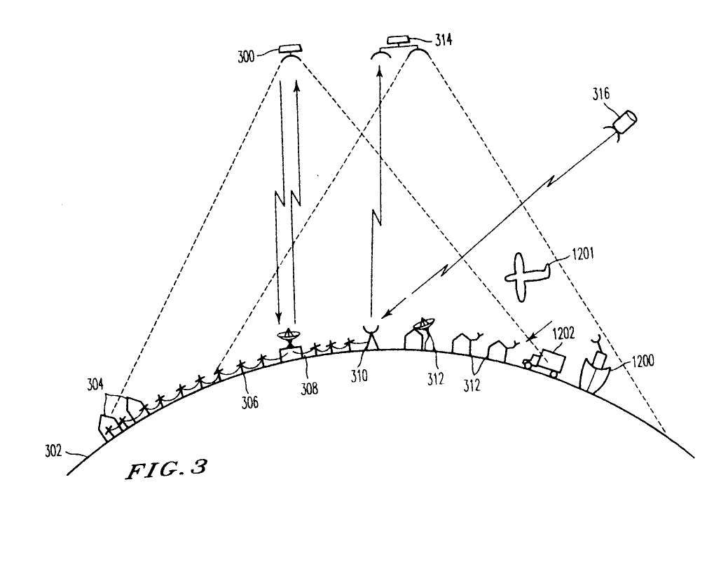

FIG. 3 is an illustrative diagram showing how imaging information is collected at GEO and distributed as real-time information to different customers. In FIG. 3, the surface of the Earth 302 is shown to be a curved surface, that limits line of sight communication from either an imaging satellite 300, 314, or communication satellite 316. The system shown in FIG. 3 is configured to allow for the collection of high resolution, real-time image data of the Earth's surface and distribute that data in real-time either directly to subscriber terminals 312 that have their own receive antenna (such as a parabolic dish, phased antenna or the like, or indirectly by way of the communication satellite 316) to teleport device 310. Customers 304 that are beyond line of sight, are more conveniently able to receive information through terrestrial mechanisms, such as the public switch telephone network, Internet connections, wireless links such as LMDS or the like, denoted as a terrestrial based communication link 306. The ground terminal 308 communicates with the imaging satellite 300 in an S-band uplink and in a X-band downlink (or Ka band downlink). Satellite 314 receives information from the imaging satellite 300 and other satellites by way of a satellite cross-link or by way of the teleport 310, as shown. The satellite 314 may then rebroadcast the image data collected at the other satellite in one of the N-1 other communications channels, where N is the number imaging satellites in the system. The satellites 300 and 314 may receive requesting information from remote users by way of the satellite uplinks through either the ground terminal 308, teleport 310 or by way of a satellite cross-link, perhaps from communications satellite 316.

As seen, ship 1200 is within the footprint of the imaging satellite 314 and may receive broadcast information directly from imaging satellite 314. The information may be in the form of weather pattern data provided real time to ships at sea so the ships at sea may adjust their navigation course according to the real-time weather information feed. In this embodiment, the ship 1200 receives the raw imaging data directly from the satellite and formats and presents the data in a visual map format. Map data may be stored on a local storage medium, such as a magnetic or optical disk, and the weather information is then overlaid on the map image. In high traffic density areas, such as the Malacca or Gibraltar Straights, weather and observations of individual ship positions may be possible allowing their correlation with accurate navigational positioning equipment to provide a means to more efficiently manage routing and collision avoidance. Notably, the presence of ship wakes (whose existence is very dependent on environmental conditions) enhances the detection by space-based platforms of even relatively small vessels.

Similar considerations apply to land and air based transportation. Observations of environmental conditions across potential routes can be examined at central processing facilities where the information can be evaluated and optimal routes selected. This information can then be disseminated to users. However, land and air vehicles are much smaller than ships and are therefore much more difficult to detect with even moderate, sub-kilometer resolution systems. However, for the right atmospheric conditions, aircraft engines will produce very visible contrails, which are known to be readily apparent from space, even at kilometer scale resolution. Road traffic will be extremely difficult to detect with a system whose resolution can barely perceive the roadways themselves, however, at night, congested roadways may become more visible by virtue of the illumination provided by thousands of headlights. The light intensity may be correlated with traffic density, information which may be coupled with other data to provide enhanced traffic monitoring.

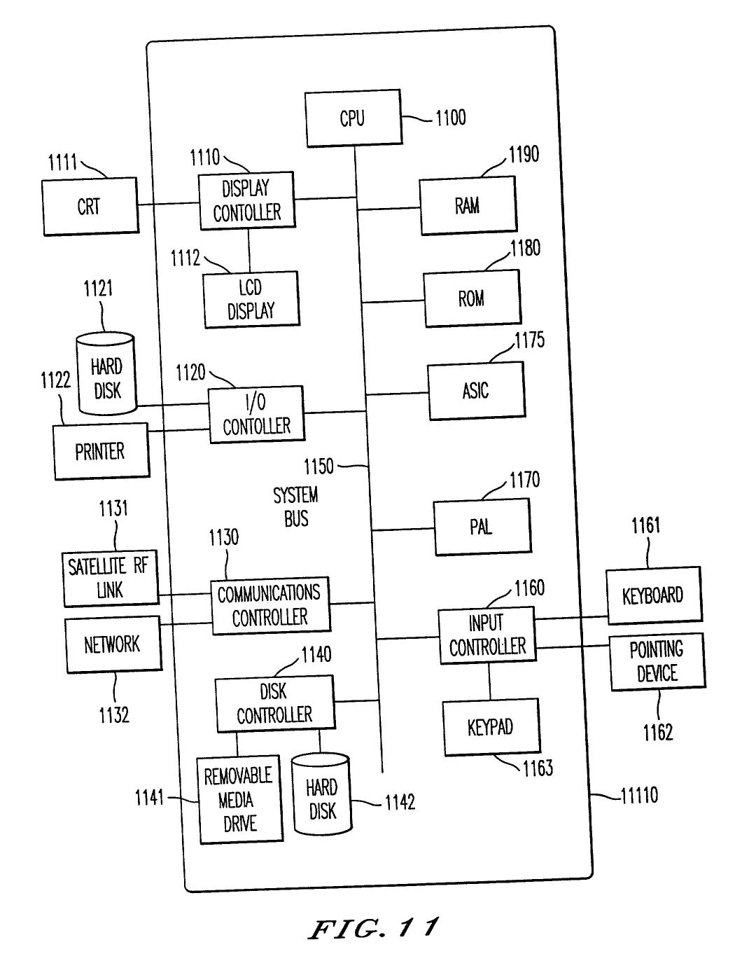

Alternatively, ground terminals 308 having a computer with an associated wireless communication link connected thereto (as shown in FIG. 11 for example), provide a weather pattern information signal that is broadcast to subscribers. This broadcast may be in the form of encrypted transmissions (encrypted with PGP, for example) so that only subscribers having encryption keys will be able to obtain the transmission. The transmission might be by way of beyond line of sight transmission such as at HF frequencies, or alternatively by way of repeat satellite broadcast for beyond line of sight communication. In one embodiment, the broadcast message includes only weather data for regions affecting that particular subscriber. In another embodiment, the ship 1200 (or other user, such as a ground-based user) may request weather data regarding specific locations.

The ground terminal 308 contains a processor configured to detect selected weather patterns and automatically create warning messages for distribution by way of e-mail or other electronic address tagged Internet alert to subscribers. Alternatively, personnel who view the weather data on a display screen at the ground terminal 308 may manually detect selected weather events and generate warning messages, followed by electronic Internet messages that warn subscribers of danger, for those subscribers who are located in the affected area, or are in the path of the dangerous weather pattern. Coupling live image data from a GEO platform with highly accurate GPS derived vehicle positions on the Earth's surface and in the atmosphere provides the means to create a three dimensional depiction of the pathway status in any transportation system. Such a visualization would be a dramatic evolution of the two dimensional depictions currently available with maps and radar screens. The three dimensional holographic depiction of a transportation system would have major ramifications for optimal route selection, traffic management, and collision avoidance. If a weather event having particular attributes (such as tornado, thunderstorm activity, certain cloud tops) is in the area of the subscriber, the ground terminal 308 generates an electronic Internet alert, such as an e-mail message, by referring to a database in which the subscriber has stored therein its e-mail message for sending the e-mail message to the subscriber either by way of terrestrial lines 306 or wireless communication mechanisms such as through GEO telecommunications satellites or a LEO based satellite constellation (e.g., Teledesec or Globalstar, for example). An e-mail function and structure like that employed in the ground terminal 308 is discussed in R. White, “How Computers Work”, QUE Corporation, 1999, and in P. Gralla “How the Internet Works”, Que Corporation, 1999 the entire contents of both of which being incorporated herein by reference. Such electronic alerts may be issued to the specific, individual Internet addresses of subscribers or to Internet access and service providers who may incorporate universal delivery of such messages as a beneficial feature.

The ground terminal 308 may also serve as a central “interpretation service” for providing predicted results of weather related data for use in particular industries. For example, the ground terminal 308 may include a mechanism for identifying particular subscribers to a service requesting weather data associated with particular weather events, in particular areas that may in fact affect commodities in those areas. When such commodity-affecting events are triggered, the ground terminal 308 generates an alert (perhaps an e-mail message, paging message or wired or wireless telephone call to the subscriber warning the subscriber of the particular effect that has been observed so as to influence commodities trading.) The ground terminal 308 may also distribute messages for transportation activities such as flying, driving, trucking or shipping. In each of these instances, wireless communication messages including rerouting messages provided from that particular transportation service are sent through wireless communication links such as a cellular communication link or satellite-relayed voice or data communication link to the mobile assets. Accordingly, an airplane 1201 may receive rerouting information due to some localized weather event that may give rise to a safety hazard for that airplane 1201. Similarly, a trucking company may opt to reroute a truck 1202 or a shipping service may opt to reroute a ship 1200 to avoid weather related obstacles that would slow down the transport operation. The transportation company may opt not to dispatch its vehicles in light of weather related events as provided by the service organized at the ground terminal 308.

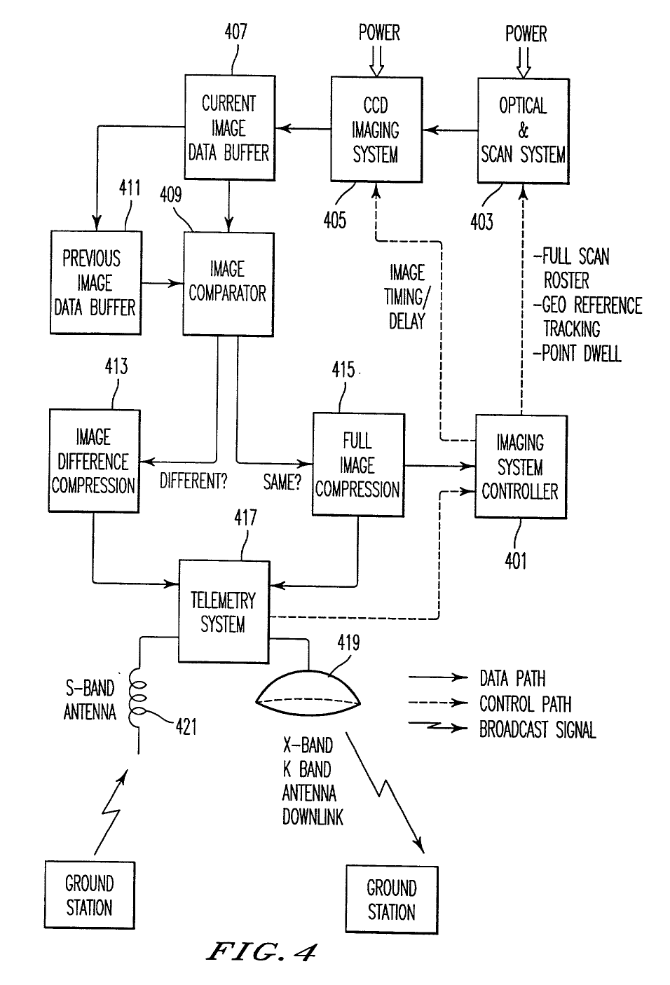

FIG. 4 is a block diagram showing the respective signal and control components of the image collection and distribution portion of the imaging satellite 300, shown previously in FIG. 3. The data capture and camera control operations are controlled with an imaging system controller 401 that provides control data to an optical and scan system 403 and CCD imaging system 405. The optical and scan system 403 includes the mechanical/optical component portion of the imaging system, where the optics are fixed. Alternatively, the optics may be controllably adjustable so as to adjust a field of view of the imaging system. In the adjustable configuration, the imaging system controller 401 provides input control signals to the optical and scan system 403 to adjust the optics within the scan system to adjust the field of view. In the present embodiment, where the optics are fixed, the optical and scan system 403 receives scan control signals from the imaging system controller 401, which in turn receives them from the ground station in an uplink transmission request message. The selectable scan types include (a) full raster scan, (b) geo-referenced tracking, which tracks a point across the surface of the Earth, and (c) pointing dwells, where the imaging system concentrates on particular portions of the Earth's surface. While three scanning operations are presently described, the present invention is not limited to performing only these three scanning operations, but rather combinations of the three operations, as well as other operations.

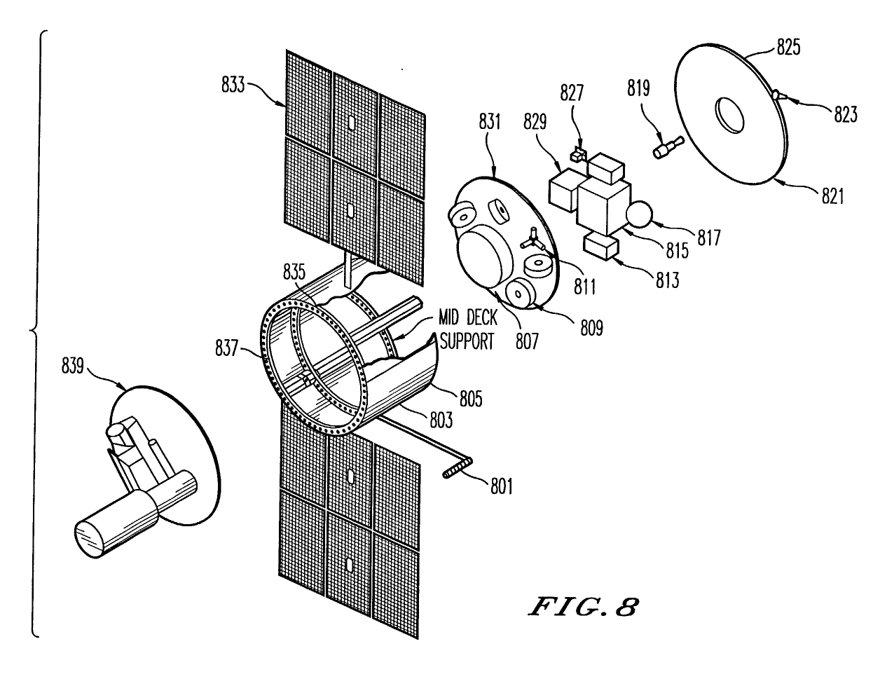

The optical and scan system 403 includes a gimbal-mounted mirror that is movable in reply to the command signals received from the imaging system controller 401. The mirror is positioned in the optical train and its orientation sets the area to be imaged on the optics focal plane. As an alternative, the entire satellite itself may be rotated partially by despinning, or accelerating momentum wheels employed on the satellite or expelling a small amount of station keeping fuel, as will be discussed in regard to FIG. 8. By moving the satellite itself, no moving parts are required in the imaging portion of the satellite.

Once the optics have been adjusted, if necessary to provide the desired field of view, the CCD imaging system 405 captures images in electronic format. The CCD imaging system 405 receives timing control signals that direct the frame rate and on/off operation. The CCD imaging system 405 includes a tiled SITe-002A series 4096(H)×4096(V) mosaic array, as described in the performance specification: SITe 2048×4096 Scientific Grade CCD, published by Scientific Imaging Technologies, Inc., Beaverton, Oreg., 97075, Dec. 21, 1995, the entire contents of which being incorporated herein by reference. Alternatively, a combination of either 2048×2048 pixel CCD or 1024×1024 CCDs may be employed, such as those described in KAI-4000M Series 2048(H)×2048(V) Pixel Megapixel Interline CCD Image Sensor Performance Specification, Eastman Kodak, Microelectronics Division, Rochester, N.Y., 14650, Revision 0, Dec. 23, 1998, and in KAI-1010 Series 1024(H)×1024(V) Pixel Megapixel Interline CCD Image Sensor Performance Specification, Eastman Kodak, Microelectronics Division, Rochester, N.Y., 14650, Revision 4, Sep. 18, 1998, the entire of contents of both of which being incorporated herein by reference. Furthermore, any combination of multiple CCD array units may be employed in multiple cameras. For example, one CCD array unit may be employed with optics that provide a fill disk image of the Earth, while a second CCD array is positioned in another optical path that captures an image of a much smaller portion of the Earth's surface.

Once the respective scenes are captured in the CCDs, the CCD imaging system 405 provides a digital output stream to a current image data buffer 407, which holds the images in memory. Previously held digital images are held in previous image data buffer 411, such that the previous image and the current images may be compared in the image comparator 409. Retaining the previous frame also assists in preparing animation loops. If the images are of the same geographic area, (fixed pointing, which always occurs for the wide field camera and occasionally occurs for the high resolution camera), the data is sent to the image difference compression processor 413. However, if the images are not of the same area, the images are routed to the full image compression processor 415.

Subsequently, outputs from the image difference compression processor 413 and full image compression processor 415 are passed to a telemetry system 417, which provide the data protocol formatting and transmission of the signal via a downlink in X-band or alternatively Ka-band via antenna 419. Uplink information from the ground station is provided through an S-band link via antenna 421.

The imaging system controller 401, current image data buffer 407, previous image data buffer 411 and image comparator 409, as well as the image difference compression mechanism 413 and full image compression mechanism 415, may be performed with one or more general purpose processors and associated memory. Alternatively, all or a selected portion of the respective operators and mechanisms may be performed using application specific integrated circuits (ASICs), field programmable array (FPGA) logic and the like.

Various compression algorithms may be employed, including standard off-the-shelf compression algorithms such as MPEG-2, for example, as is explained in Haskel, B. et al, “Digital Video: An Introduction to MPEG-2”, Chapman and Hall, ISBNOI-412-08411-2, 1996, the entire contents of which being incorporated herein by reference.

The advent of multi-megapixel CCD arrays has made it possible to employ electro-optical systems to obtain coverage of most of the Earth at visible wavelengths, around the clock, and at sub-kilometer resolutions. The method of creating images most simulates the characteristics of the human eye, where the eye itself uses a two-dimensional array of light sensitive detectors able to discriminate “color” and operate in a degraded mode at low light levels. Recent advances in technology have resulted in the creation of multi-megapixel CCD arrays, such as the 2048×2048 Kodak KAI 4000 so that much better resolution can be achieved with a single, starring imaging system. An exposure of only milliseconds in duration is required to create a complete image in daylight, which is much less than the presently defined “real-time” application. With such CCD arrays, an image can be created under GEO night illumination conditions in about one second's time.

As previously discussed, “spin-scan”, “flying spot”, and “time delay integration” imaging systems are not practical for providing either “real-time” or “around the clock” coverage of the Earth's fill disk from GEO. Early proposals to use two-dimensional CCD megapixels were limited by the size of the devices as compared to the size of the Earth. These earlier studies and proposals focused on the ability of sub-megapixel arrays to create coverage of the sunlit Earth in a few minutes, but never considered the interaction between the value of obtaining a seamless sequence of images and allowing the images to be processed with the human eye and brain.

In past schemes, to create a mosaic of the Earth's full disk made up of two-dimensional frames required images to be acquired too rapidly to allow for adequate time exposures. The ability of such a system to image at low light levels is thus compromised. In contrast, two-dimensional multi-megapixel CCD arrays provide a factor of 8 improvement over previous proposals. Individual frame times of up to a second are possible where only about 100 frames are required to create a mosaic of the full disk. With a maximum exposure time of one second, day and night coverage of the full disk is possible. The time required to create a step-stare mosaic of the Earth is merely a factor of 2 faster than previous methods with image smear accordingly reduced.

For space applications, frame transfer CCD arrays (such as Kodak's KAI series and the larger S.I.T.I. ST series) are preferable because they can be electronically shuttered, reducing the susceptibility to mechanical failure. The addition of integrated pixel filters in a CCD (such as the color version of Kodak's KAI series) allows multi-spectral measurements to be made in a single frame. As frames are compiled in resampling of a given geographic region, its full multi spectral character can be revealed. The class of mechanically shuttered, or full frame CCD arrays such as Kodak's KAH series are as large as 4096×4096 and even larger, which offer the advantage of either increased area coverage or an equivalent area at improved resolution. The addition of either a mechanical filter wheel or a split beam optics architecture with multiple CCD arrays allows multi spectral images to be created at a somewhat slower rate, albeit much faster than the current panchromatic images created by spin scan and flying spot systems.

Finally, the multi-megapixel CCD array based imaging system presented in the present document is small enough in mass and volume and uses sufficiently little power in operating that providing a satellite with multiple electrical-optical sensors is a viable option and is an alternative embodiment. The advantage of multiple sensors becomes apparent in the event of failure or if the normal full disk scan is halted in order to provide high temporal coverage to a particular geographic area. In this event, the additional imaging system can maintain the full disk coverage, either by design at lower resolution or operationally with less frequent sampling of the full disk, alternating with the dwelling adjustments as required.

The global system provided herein is of a satellite carrying at least two visible imaging systems, each of which employ a multi-megapixel two-dimensional CCD array to instantaneously capture all reflected light at visible wavelengths within the design spectral range and field of view. The field of view of each system progresses from larger to smaller as the spatial resolution offered increases from coarse to fine. The widest field of view provided by the system with coarsest resolution encompasses the entire full disk of the Earth as seen from GEO (17.3). The optical bore-sights of all other systems are free to point and can be scanned within the area covered by the widest field of view to create the mosaic of high resolution hemispherical scale images in real-time while ensuring the most accurate image navigation and registration possible.

For example, the CCD imaging system 405 (FIG. 4) incorporates as one of the CCD devices, a 2048×2048 focal plane CCD frame transfer detector array with electronic shuttering so as to provide virtually instantaneous images of the Earth's day and can be created at about 5.5 km of nadir resolution. The satellite has adequate stability to allow the same system to operate in a timed exposure mode to collect images of the Earth at night levels of illumination. The second system, with the same CCD array, operates with 500 meter spatial resolution in series with the wide field instrument. The instrument uses a step-stare scanning scheme to create a full disk image in less than two minutes. Most of the Earth observed by this system is observed at sub-kilometer resolution. As an alternative, a 4096×4096 array may be included either to augment the 2048×2048 CCD, or as a substitute therefore so as to improve the system performance, albeit while quadrupling the data rate required to achieve the same coverage performance, thus requiring a larger telemetry bandwidth than 15 MHz per camera.

Regarding a suite of cameras that are hosted on the satellite, the general capabilities of the camera systems include a wide field RGB camera to provide full disk coverage. Furthermore, at least one, perhaps two, narrow field RGB cameras with half kilometer, or better, resolution over approximately a 1,000 kilometer square area are included. As discussed above, a hyper-spatial resolution mode may also be operated where much better (at least 100 m, but as high as 10 m or better) resolution is employed. The narrow field RGB camera is pointable (steerable) over the entire earth disk. A near infrared narrow field camera is also provided with a same resolution and provides coverage in the IR band. A low-light narrow field camera is also provided with a same resolution and coverage as the narrow field RGB camera, for night observations and for providing data that correlates with visible band pictures at less than full moonlight with data from the near infrared narrow field camera. This low-light narrow field camera is steerable over the entire earth disk. A multi-spectral camera may also be provided with a coverage that equates to that of the narrow field RGB camera and with the same spatial resolution as the narrow field RGB camera and building multispectral mosaic images of the earth's full disk in multiple visible, near-IR and near-ultraviolet bands using the same step-stare scanning technique. This camera is pointable (steerable) over the entire earth disk.

In an alternative configuration, the satellite may include the following communication and imaging subsystems. The satellite may use a pair of 80 MHz wide band downlinks to transmit compressed data from sensors and telemetry data regarding health and status of the spacecraft. A 10 KHz narrow band uplink is used for TT & C. The TT &C link is used to select the sensors and to set the rates of data acquisition. An additional narrow band uplink is available for contingency purposes. The downlinks operate at X-band and the uplinks operate at S-band. The S-band uplink frequencies may be allocated on a co-primary basis to fixed service and mobile service. In order to increase the isolation from one another, LEO EESS systems use right hand circularly polarized (“RHCP”) links, while the present invention may use left hand circularly polarized (“LHCP”) links (or vice versa) so as to provide a greater degree of isolation between the two systems.

For the downlinks, primary downlinks for the satellite may use a center frequency of 8065 MHz through 8330 MHz with bandwidths of 80 MHz per channel for a total of 160 MHz total bandwidth. The downlink data is compressed and then interleaved with telemetry data that reports the satellite's health and status. The compression of multiplexing functions may be performed by a command and data handling subsystem that is located in an on-board central processor. The processor also encrypts all of the data using keys that are modified on ground command. The command and data handling subsystem performs Viterbi and/or Reed-Soloman encoding before passing the data to the transmitter. A combination of Viterbi and/or Reed-Soloman coding is used to ensure a decoding bit error rate of better than 10⁻⁶ at all continental United States (CONUS) based ground stations. The primary downlink communication system uses two 6-watt wide band X-band transmitters using QPSK modulation. Alternatively, higher throughput modulation schemes may be used as well, such as M-ary signaling schemes.

The antenna on board the satellite may also use a high gain, primary focus fed, parabolic dish with a diameter of about 3 feet with a half maximum beam width of approximately 2.58° for the lower frequency channel and approximately 2.5° for the upper frequency channel. The antenna is mounted on a limited-motion, two-axis pointing platform that allows the antenna to be accurately pointed to the ground station to which it is communicating.

A primary uplink used for telemetry, tracking and command links may be 10 KHz wide with a center frequency of 2060 MHz. The uplink uses BPSK modulation with viterbi coding.

In normal operation, each of the two narrow-field-of-view cameras has a frame rate of at least two frames per second (although only one narrow-field-of-view camera may be used). The wide-field-of-view camera that provides an image of a full disk of earth, has a frame rate of at least one image per second. The combined raw data rate of these cameras is an excess of 250 Mbps per second before compression, when the narrow field of view cameras operate sub-kilometer resolution. Of course, greater transmission capacity is required when operated in hyper-spatial resolution mode. When additional sensor data and housekeeping data are added, the data rate before compression exceeds 3 Mbps. When using “loss-less” compression a nominal compression advantage of 2 to 1 can be readily achieved on an ongoing basis. After encryption, error and correction encoding and use of QPSK modulation (2 bits per channel symbol) in the X-band downlink, the data stream efficiently utilizes the two 80 MHz downlink channels.

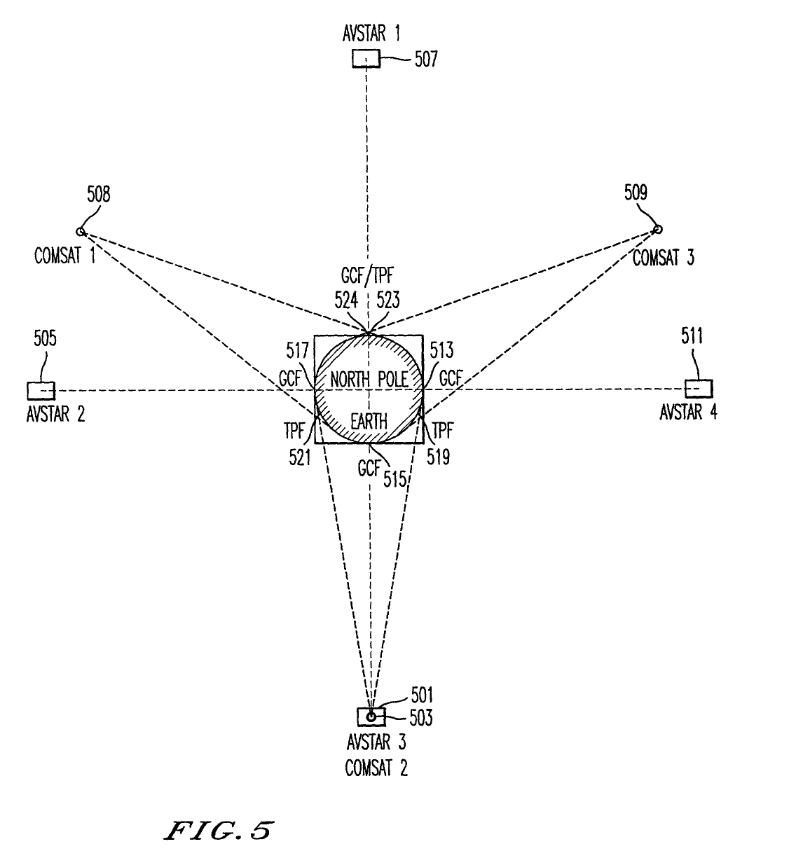

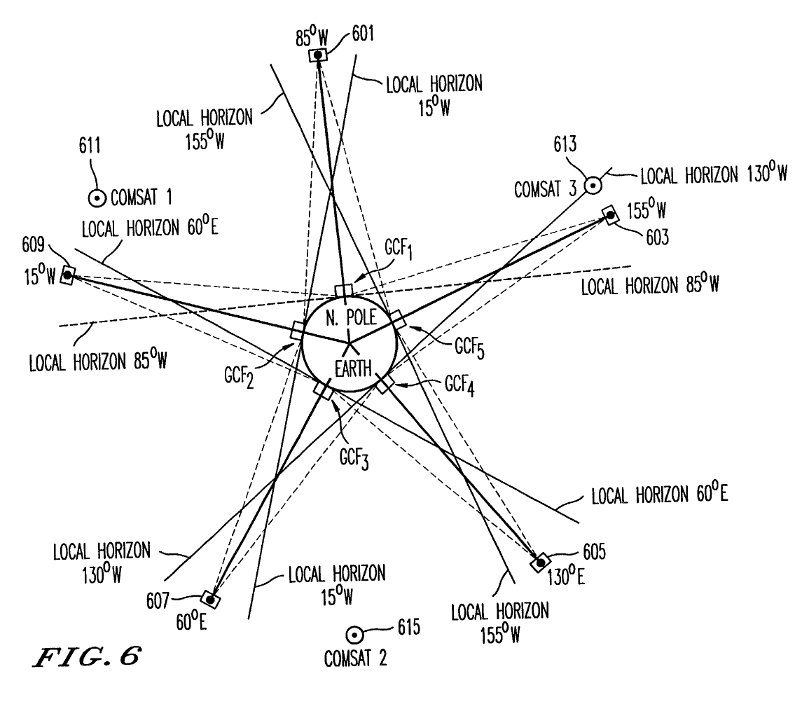

Regarding the method and system for providing global coverage, the present discussion now turns to the relative positioning and numbers of satellites employed at geostationary orbit. To cover most of the Earth from GEO, at a spatial resolution of better than 1 km, requires a constellation of at least four satellites, as is shown in FIG. 5. FIG. 6, as will be discussed, shows a system with 5 imaging satellites.

Before discussing the details of the constellations in FIG. 5 and 6, it is first relevant to recognize that a single GEO satellite with a full disk imaging system provided at a nadir resolution of 500 m is able to observe the Earth's disk between about 75° North and South latitude and plus or minus 75° East and West from the nadir longitude. The effective area of regard is found by inscribing a full circle on the surface of the Earth with its center at the satellite nadir point. In this case, effective coverage is defined by the circumference created by intersection of the Earth's surface within a cone 75° in radius with vertex at the Earth's center, or it can be shown with a cone of diameter 17.3° and vertex centered at GEO, as shown. With many satellites, coverage to 75° North and South latitude or 96.6% of the Earth's surface, would be both continuous and complete. However, the number of expensive satellites must necessarily be limited and the image resolution degrades with distance from the sub-solar point. Higher resolution optics provides a wider cone of coverage. A system providing a half-kilometer at nadir provides about 1 km resolution within an area defined by an Earth centered cone of angular radius of 52.5°.

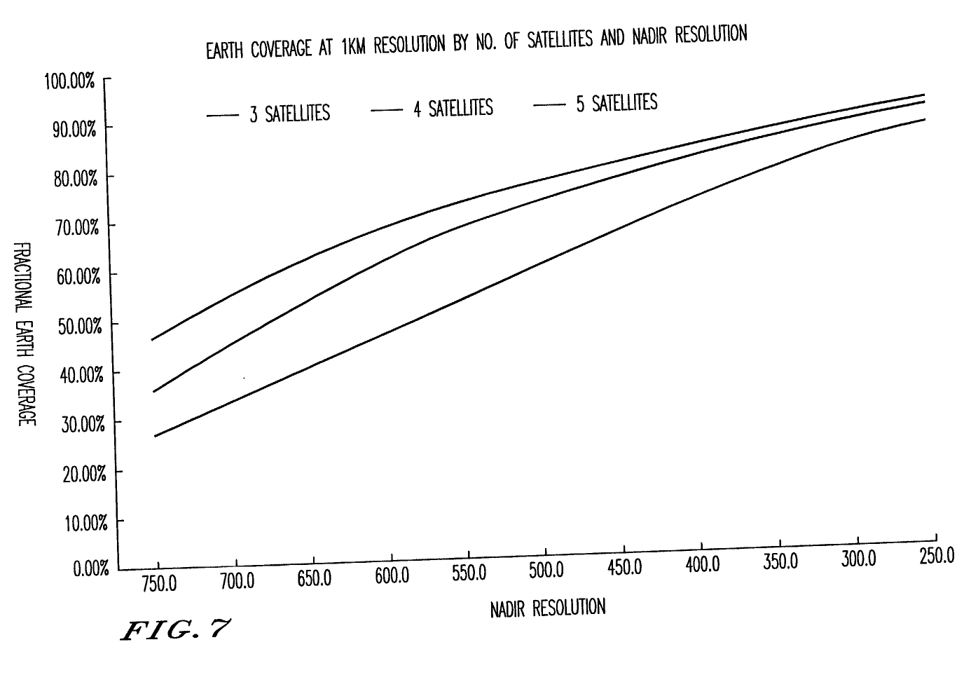

For example, as seen in FIG. 7, three equally spaced satellites can provide sub-kilometer coverage to less than 50% of the globe with a 500 m resolution system. Even with 375 m resolution optics, significant gaps in coverage remain at low and mid-latitudes. In contrast, as shown in FIG. 7, four satellites fill in the gaps and can provide the same level of coverage to nearly three quarters of the Earth. Thus, to cover most of the globe at sub-kilometer resolution, at least four satellites are needed to be equipped with an imaging system having approximately half kilometer resolution. FIG. 7 shows that there is an incremental improvement in increasing from 4 satellites to 5 satellites.

The four satellite arrangement is shown in FIG. 5, with four different imaging satellites 501, 505, 507 and 511. The satellites are augmented with communication satellites 503, 508, and 509. The imaging satellites 501, 505, 507, and 511, as well as the communication satellites 503, 508, and 509, correspond with ground control facilities 515, 517, 523 and 513 as shown. In addition, communication relay teleports 521, 524 and 519 are provided to provide a relay capability. The purpose and function of the relay capabilities are to assist in the global dissemination and distribution of data captured by the imaging satellites when line-of-sight communications is not possible.

Regarding the global image distribution feature, each of the imaging satellites 501, 505, 507 and 511, transmit image data to the ground using a space to ground communication link, either a X-band or alternatively a Ka-band link using X-band or KA-band transponders. The satellite antenna is shaped and sized to provide a footprint to cover nearly the entire visible hemisphere. Alternatively, the antenna might be configured to provide specific spot beams that may be directed to particular geographic locations to support particular customers. Image data can be broadcast from each satellite directly to users anywhere within the satellite's line of sight. It is also possible to distribute the real-time data from one receiver site using leased transponders on commercial communication satellites 503, 508 and 509. As the capacity of terrestrial based networks, such as the Internet increases, the commercial communication satellites may help supplement this structure, as well as wireless communication nodes such as LMDS as the like. Using the global infrastructure for telecommunications and data distribution, the present invention contemplates incorporating hemispheric distribution from a single receiver sight for each satellite either in a “push-pull” architecture as a separate broadcast or as data available by “pull” via the Internet or other terrestrial based network. The term “push-pull” denotes data that is continually broadcast or can be interactively requested. Data can be pulled off the Internet as often as needed.

Real-time data must be distributed beyond each satellite's line of sight or its GEO horizon. This can be done using a leased transponder bandwidth on a network of at least three commercial communication satellites, or alternatively, using cross-linked connections between the imaging satellites, or a combination of the two.

Real-time global distribution of multi-megapixel images requires that the remote sensing platform space to ground communication sub-system have adequate telemetry bandwidth to transmit data as fast as it is collected. The amount of bandwidth actually required, typically about 15 MHz per channel, can be decreased by data compression techniques. Enough bandwidth should be allocated on each communication satellite to carry the data from each satellite element of the constellation, which includes at about 15 MHz of bandwidth for each camera on each satellite. Although three communication satellites provide a communications link between the hemispheres, gaps in coverage exist since much of the Earth's surface at mid to high latitudes between satellites is not in direct line of sight. Just as four GEO observing platforms provide more complete coverage of the surface, four communication satellites, spaced equally around the globe can broadcast data directly to end users, at least until high capacity ground communications links are fully developed in all regions of the world.

Distributing data by commercial telecommunications satellites requires at least one ground station for each imaging satellite to act as a “bent pipe”. This station re-routes data that it receives directly via a standard ground-based communications line to at least one “teleport” where it is transmitted to the communications satellite for further distribution. The teleport facilities may also act as bent pipes for accepting data transmissions from other imaging satellites positioned beneath the local horizon. Ultimately, a communications satellite above the horizon of any point on Earth between about 70° North and South latitude will distribute data from those satellites which are below the local horizon, and for which direct broadcast is not possible. Moreover, to avoid a distribution bottleneck, the data is preferably broadcast over a wide as possible area so as to allow reception anywhere within the line of sight of the satellite.

FIG. 6 is similar to FIG. 5, although five different imaging satellites 601, 603, 605, 607 and 609 are provided. In the scenario shown in FIG. 6, three communication satellites support around the world communications for distributing the data received at the imaging satellites. Of coarse, additional communication satellites and teleports may be used as well.

FIG. 8 is an exploded diagram of the imaging satellite employed in the present invention. Communications antennas are included on the satellite such as antennas 801 and 823, which provide communication links for control and data distribution. The structure of the satellite includes star sensors 803, radiators 805, thrustors 837 and payload support 835. The star sensors 803 serve as attitude control mechanisms that detect a relative position of the satellite and Earth so that the imaging system may be properly aligned. Solar panels 833 provide power to the system. In addition, various batteries 825 are provided on the off-deck 821 and provide power to a main motor 819. Pressure tank 817 is hosted on an on-board processor 815 which provides system control functions. The transponders 813 are included to provide a communication capability between the satellite and other satellites in a cross-link or to a ground station. Accelerometers 811 and momentum wheels 809 provide the mid-deck 831 portion of the satellite with an ability to stabilize the satellite. In one alternative embodiment, the scanning operation performed by the satellite when scanning across the Earth's image is performed by despinning the wheels 809 by a predetermined amount so that the satellite rotates a specific amount in order to capture the desired image according to a particular scan sequence. This scanning operation is performed in coordination with an inertial reference 827, so that the amount of satellite spin is controlled. Communication data link 829 provides a proprietary data link for supporting X-band or KU-band communications for example to support the at least N channels of communication used to distribute data. Payload deck 839 supports the imaging portion of the satellite that captures images of the Earth.

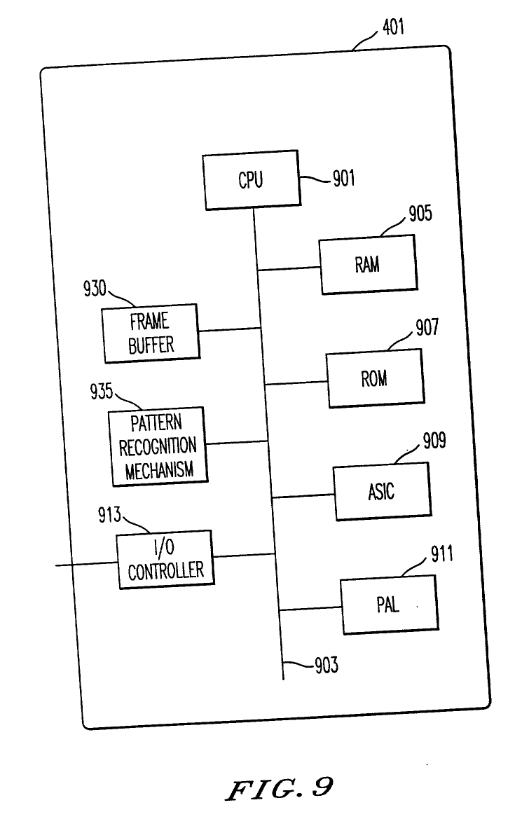

FIG. 9 is a block diagram of the imaging system controller 401 previously described in FIG. 4. The controller 401 uses a system bus 903 to interconnect a CPU 901 with associated hardware. In particular, the CPU 901 receives software instructions from ROM 907, which contains control algorithms to implement either full disk operation, GEO-reference tracking operation that tracks a point across the surface of the Earth, and a dwell point determination algorithm so as to have the imaging system dwell in a particular direction for a predetermined period of time. RAM 905 holds temporary data, that may be used when receiving data from the telemetry system 517 (FIG. 4), as well as decision information provided by the image comparator 409 by way of the full image compression mechanism 415. ASIC 909 and PAL-911 cooperate with the CPU 901 to perform in a hardware fashion, algorithms that are optionally performed in the CPU 901. Outputs from the CPU 901 are passed through an I/O controller 913, to the optical and scan system 403 (FIG. 4) and CCD imaging system 405 (FIG. 4).

A frame buffer 930 is connected to system bus 903 where the frame buffer 930 receives one frame of information at a time from the satellite imaging system and adds, averages and normalizes that frame of data with other frames of data taken at adjacent points in time so as to improve on the resolution for a particular image when the satellite imaging system is operated in a hyper-spatial resolution mode. Moreover, by averaging the video frames, the effective resolution of the imaging system is improved. Alternatively, if the satellite is operated in a spot-steering mode of operation where the full disk of the earth's image is not selected, but rather the particular region on the earth's surface is dwelled-upon based on a user's request received through IO controller 913, then the amount of light energy that is processed and collected by the imaging system increases and provides for more accurate representation of the earth's surface that is the subject of the imaging system.

Pattern recognition mechanism 935 is also connected to the system bus and includes therein background images of selected portions on the earth's surface that have highways and other paths over which subscribers have requested information regarding traffic congestion. Moreover, the pattern recognition mechanism 935 includes a database of pre-saved images of predefined traffic levels for regions served by subscriber areas. Each of these subscriber areas are cataloged by a subscriber number in the database for easy retrieval. When a subscriber requests congestion information (or alternatively on a predetermined, scheduled basis) the pattern recognition mechanism 935 retrieves from the frame buffer 930 the contents of the frame buffer and compares the same against the pre-saved area of the region under analysis. Analysis may be based on variations in either color or the intensity of reflected or emitted light. The pattern recognition mechanism 935 then makes a determination whether the contents of the frame buffer 930 is sufficiently close to predetermined threshold level (e.g., strong correlation with a stored image of high traffic congestion) to decide that traffic congestion for a predetermined section of highway is “high”, “medium” or “low”, although more degrees of congestion could be used as well. The pattern recognition mechanism provides a difference operation between the saved pattern and the image information contained in the frame buffer 930 and using any one of a number of detection algorithms (such as least mean square determination), identifies which of the congestion patterns is the most likely to be present for that particular geographic region. Once the determination is made, the pattern recognition mechanism 935 sends a congestion level message to the CPU 901 for sending to the ground terminal by way of IO controller 913.

Alternatively, the process of recognizing the amount of traffic congestion may be performed at the ground terminal using the processor and memory features of the terminal shown in FIG. 11 for example. However, in the present embodiment the CPU 901 produces a traffic congestion message and transmits the traffic congestion message through the IO controller 913 to the ground station for dissemination to subscribers that have requested the traffic service information for subscribers.

Hyper-resolution Imaging from Geostationary Orbit

Providing coverage of the Earth from geostationary orbit at optical wavelengths is what is termed herein as “hyper-resolution” and has a meaning of providing very frequent images of the entire viewable Earth's surface at spatial resolutions comparable to current systems in low earth orbit. Quantitatively, hyper-resolution refers to coverage of the entire viewable Earth at temporal resolutions more frequent than every 2-3 minutes, at spatial resolutions significantly better than a pixel instantaneous field of view (IFOV) of 100 meters. Alternatively, hyper-resolution may be employed with spot-steering is employed, where the space-based optics are not scanned in a continuous manner, but rather kept to dwell at predetermined locations on the Earth's surface on an on-demand basis.

System Design Considerations for a GEO based Hyper Resolution Coverage System (GHRCS)

Communications Considerations:

The FCC allocates the X- and Ka Band for Space to Earth communications for satellites engaged in passive Earth exploration. There is 375 MHz authorized in the X-Band (8,025- 8,400 MHz) and 1.75 GHZ authorized in the Ka Band (25.25- 27.00 GHz). X-Band capacity is 375 Mbps and Ka Band capacity is 1.75 Gbps, which characterize a largest amount of uncompressed data that can be transmitted per second, and the corresponding highest resolution coverage for the Earth. For an embodiment that achieves “live” coverage of the Earth's full disk, under the definition stated earlier, then a scan of the earth's full disk is performed every 2 minutes. The exact spatial and temporal resolution would be a trade off to arrive at the exact value commensurate with this limiting value. Assuming data compression (of say 100:1) increases this limitation. This provides one approach to setting a limit to the capability of the GHRCS.

The image size=1.75 Gbps * 120 sec/Full Disk * 100/8 bits/Byte=2,625 GB/Full Disk or 2.625 TeraBytes/Full Disk. At one Byte per image pixel, this is an array of 1.62 million pixels on a side, but it is also possible to employ a multi megapixel array that is scanned across the earth's disk to solve the array size problem.

The size of the Earth's full disk is 17.3° or 0.302 radians, which means each pixel must subtend approximately 0.19 microradians. This translates to a nadir resolution of 6.8 meters. This value might also be achieved by DSP or HST, if it were placed in GEO to look back at the Earth and changing the telescope's optics, once adapted for the present application (as would be readily understood by an optics engineer). The mere size of the HST makes it difficult to perform a raster type scan across the disk of the Earth to build a mosaic image. Even assuming a multi megapixel array, with a “footprint” or “field of view” of only 680 microradians, over 200,000 separate frames would be required to complete one full disk image. In two minutes, that amounts to 600 microseconds integration time per frame, which will operate best in the brightest sunlit conditions.

Alternatively, the hyper-resolution mode of operation need not operate in a scanning mode, but rather a spot-steering mode of operation where the optics are trained on certain geographic areas that are in need of high resolution images, such as for traffic congestion applications. In this situation the area in which the satellite optics are trained, is provided by way of a request from a subscriber, or even a group of subscribers such that only areas covered by the subscribers as well as candidate subscribers will be covered in the areas in which the satellite's optics will be trained. For example, in a spot-steering mode of operation, the surface of the Earth that is covered with water is not scanned but only areas in which traffic congestion information is useful, such as over the large land masses of the populated areas, is the subject of the spot steering mode.

In this illustrative embodiment, the optically altered HST is positioned in GEO operating with a composite detector of approximately 3,200 pixels on a side, made up of 16 of its current 800×800 detectors, set 4 on a side. Two alternative mitigation techniques are available. First, using a large detection array, the resolution can be degraded somewhat to mitigate array construction cost and manufacturing complexity. Thus, in this embodiment the system uses a 2×2 array of 4, 4096×4096 Kodak detectors to provide a detector array whose size is effectively 8,192×8192 pixels. Assuming a resolution of 10 meters, the angular pixel size is about 0.3 microradian. 8,192 pixels provides a field of view of 2.46 milliradians. Now only 15,100 separate images to create a mosaic (although even fewer are required to operate in the spot-steering mode, where specific locations are optically analyzed). In this case, the frame integration time is about 8 milliseconds, which is adequate for imaging the Earth though most normal daylight conditions. However, in the mosaic mode of operation, moving the telescope to scan across the Earth's disk, raster style from East to West and North to South requires a complex steering system.

As an alternative to scanning the telescope, an alternative embodiment is to point the telescope away from the Earth's nadir and toward a rotating faceted reflector (incorporated into the optical and scan system of FIG. 4) placed to reflect light from the earth back into the primary optics of the telescope. The faceted reflector would be constructed with an array of stepping mirrors, to provide the raster scan needed to cover the Earth. In this way, the much smaller and less massive reflector would be decoupled from the satellite, insulating it from the motions and vibrations that would otherwise be induced in the primary instrument. The reflector would rotate parallel to the rotational axis of the Earth so as to minimize stabilization problems which would disrupt the integrity of the mosaic image, as well as minimizing the expenditure of reaction gas to stay on station.

Night side imaging would remain problematic due to the lower light levels, unless the scan area is reduced, or a different system is used, with resolution optimized (reduced) to provide coverage at night. Alternatively, the night side system would simply use an ultra-sensitive detector array coupled with an image intensifier, of the sort employed in low-light TV.

As a further embodiment, the number of detector arrays is increased at the telescope's focal plane. Increasing the array size to 4×4, or 16 such detectors would result in a very large improvement in its performance, although it would be a more expensive solution, requiring larger power requirements. A 5 milliradian field of view would mean the number of frames required to scan the full disk would be reduced to about 3650, or 33 milliseconds per frame integration time.

Using the spot-steering embodiment, the HST would employ an optically sensitive recording device (e.g. a large CCD array) at the focal plane that enables the collection of optical information in a particular geographical region, thus enabling 1 meter resolution, albeit at the expense of not providing full-disk imaging.

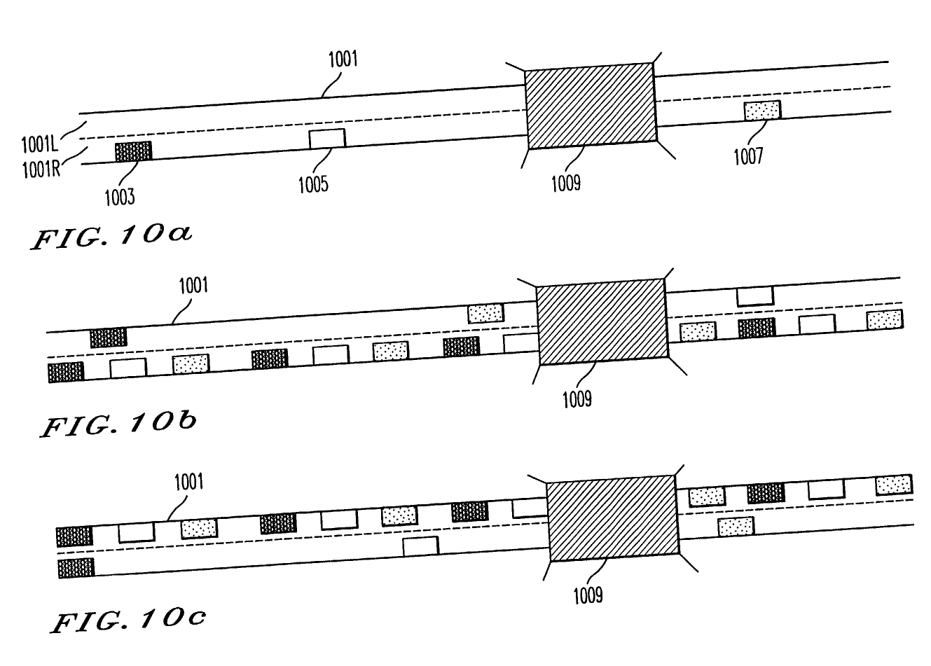

FIG. 10a shows a highway that is the field of view of the satellite's optics while operating in a hyper-resolution mode of operation (either scanned or dwelled). The highway 1001 includes both a left-hand lane 1001L and a right-lane 1001R. In the right-hand lane, as can be seen, is a dark vehicle 1003, a light vehicle 1005 and a medium-shaded vehicle 1007. The imaging system on the satellite receives reflective light energy from the different vehicles as well as the scenery surrounding the road 1001. The received optical energy at the satellite is then be compared against a background image of the particular scene that has a predetermined amount of traffic congestion in a particular lane. The region covered by satellite optics in the spot-steering mode is divided by a grid where each grid has specific identifiers that have associated therewith background images saved in a pattern recognition mechanism. Subscribers to the traffic congestion service may send a message (digital or analog) with particular identifiers for the geographic region of interest to this particular subscriber, and the pattern recognition mechanism (FIG. 9) will prepare and provide congestion related information to the CPU for preparation of a response message that reports the amount of congestion for a particular subportion of the region in which the satellite's optics are trained. Using this congestion information, the services provider or end user themselves may overlay an indication (such as a color, like red for heavy congestion) on roadways presented on a computer generated map display. The motorist may then use this information to find the least congested traffic routes, or in proposing new traffic routes to minimize the amount of travel time. Such mapping programs are available in many modern vehicles including a user-observable display screen in which routes are provided including travel recommendations for planning routes. Using the congestion overlay information the display system may recommend alternative routes that avoid (or at least consider) the amount of congestion which the presently recommended route experiences.

The amount of reflected light received, and thus the observed amount of contrast against the particular road, is a function of the color of the vehicle that falls within a particular screen. However, on average, the larger the area that is being observed, the likelihood is that there will be a fair number of cars with a sufficient reflectivity so as to provide a contrast between a highway surface and the certain percentage of vehicles that have a highly contrasting gray scale. Also, temporal data may be used to compare adjacent frames to determine if those vehicles with a high contrast have progressed down the highway, where the congestion is observed as function of vehicle distance as a function of time.

FIG. 10b shows a situation where the left lane of traffic 1001L has much less congestion than the right lane of traffic 1001R. In this situation the traffic congestion information message produced at the satellite (or alternatively at the ground station) is transmitted in a lane-specific congestion message to the end user or the mapping service. FIG. 10c shows another situation where the left lane 1001L is more congested than the right lane 1001R.

FIG. 11 shows a computer facility employed at ground station 308 for producing email warning messages, congestion traffic information messages and receiving requests for congestion traffic messages. Similarly, the terminal 11110 of FIG. 11 is also configured to provide an intermediary communication facility for transmitting weather-related information and imaging data to a Maritime vessel such as ship 1200 (FIG. 3) such that the ship 1200 receives updated weather information either through direct broadcast or rebroadcast through terrestrial mechanisms or LEO communication facilities. Terminal 11110 is inclusive of a number of items that are interconnected by way of a system bus 1150. The bus 1150 connects a CPU 1100 to RAM 1190 for holding temporary results and buffering image data provided to the satellite as well as performing service request messages and producing and temporarily storing e-mail messages for distribution to subscribers regarding the warning of particular weather events in their area.

ROM 1180 saves as program memory computer readable instructions executed by the CPU 1100 so as to implement the methods discussed herein. In lieu of the operations performed by the CPU 1100 or as a supplement thereto, an ASIC 1175 and Programmable array logic 1170 also connect to the system bus to provide specialized computer operations. An input controller 1160 connects to the system bus and coordinates messages for being input through way of a keyboard 1161, pointing device 1162 or on-housing keypad 1163. In this way, an operator who locally operates the terminal shown in FIG. 11, may operate the system and make necessary operation decisions and control. A disk controller 1140 connects to the system bus 1150 and has connected thereto a removable media drive 1141 and hard drive 1142. A communications controller 1130 also connects to the system bus 1150 and provides a mechanism by which data is sent in a bi-directional mechanism through a satellite radio frequency link 1131 or over wireless or wired terrestrial networks (which may include a LEO link) in network 1132. An I/O controller 1120 interconnects an external hard disk 1121 and printer 1122. Display controller 1110 interconnects an internal LCD display 1112 and a CRT 1111 which are used for preparing maps and messages to be distributed to subscribers.

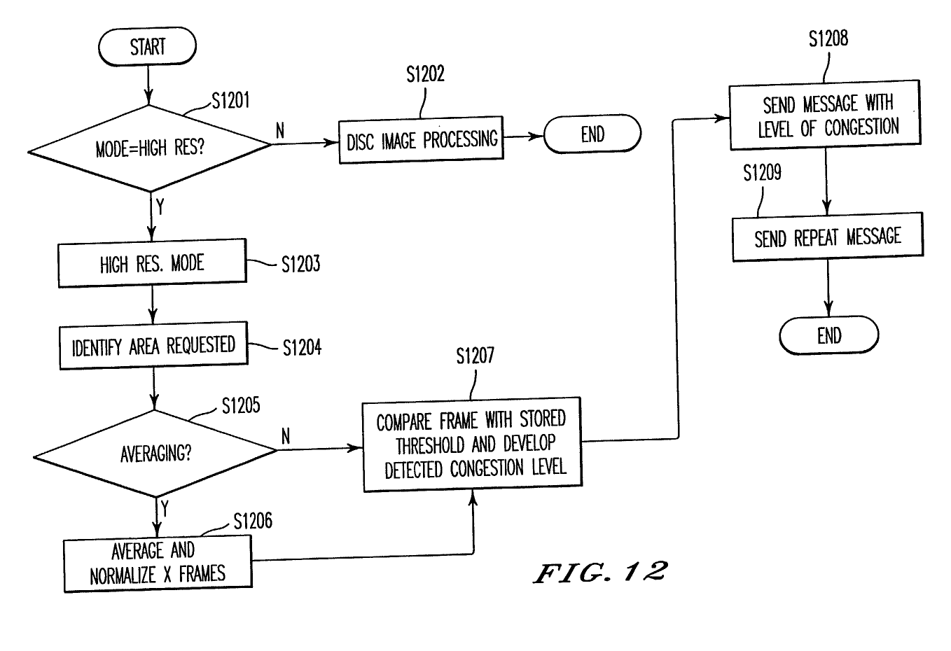

FIG. 12 is a flowchart explaining a process flow for controlling a high-resolution mode of operation and generating traffic congestion information as observed from geostationary orbit and producing a message for use by a traffic congestion message information service. The process begins in step S1201 where an inquiry is made regarding whether the satellite is operating at a high resolution mode of operation in which a 10 meter or lower resolution is achieved. The high resolution mode of operation inquiry also relates to whether the satellite optics are scanned to provide a full disk image or not. If the response to the inquiry in step S1201 is negative the process proceeds to step S1202 where a conventional image processing of an entire disk is performed and the process subsequently ends. However if the response to the inquiry is affirmative, the process proceeds to step S1203 where the high resolution mode of operation is performed perhaps with full disk imaging if selected.

Subsequently the process proceeds to step S1204 where specific areas may be identified by subscribers to ensure that if operated in a spot-scan operation, the image data collected will be for the selected area. The process then proceeds to step S1205 where an inquiry is made regarding whether frame buffer averaging is performed so that enhanced resolution can be achieved if sufficient time is available for multiple frames to be captured for a particular area. If the response to the inquiry in step S1205 is affirmative, the process proceeds to step S1206 where an average of adjacent frames is taken and the resulting frame is normalized after compiling and averaging a predetermined number of frames (x, such as five frames). The process subsequently proceeds to step S1207 where the resulting frame is compared with a stored frame and the difference between the two frames is compared with the threshold so as to determine if the level of difference is sufficiently small to indicate that the observed traffic is equivalent to a certain predetermined congestion level associated with the stored image frame. The process then proceeds to step S1201 where a message is sent to the message congestion service provider (service provider) by way of either RF communications or through digital communication over terrestrial networks. The process then proceeds to step S1209 where the service provider or the subscriber themselves may request additional messages be prepared regarding the traffic congestion based on the particular location at which the subscriber is presently located. Subsequently the process ends.

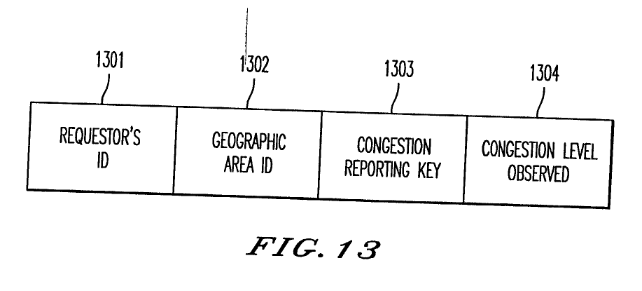

FIG. 13 is a data structure showing the content of a particular message provided by the ground terminal system (alternatively the satellite system) so as to report the level of traffic congestion information to an end user or a subscriber service. A first data field 1301 contains a requester's identification. This requester's identification is compared against a database so as to determine if that particular requester is authorized to use the service. Data field 1302 includes the geographic area identification for particular subscribers so as to ensure the satellite provides appropriate data regarding that particular geographic area to the subscriber. Data field 1303 includes a congestion reporting key which indicates the different levels of congestion according to certain predetermined levels associated with degree of congestion (not moving, moving slowly, little congestion). Data field 1304 then includes a observed congestion level indicator, that corresponds with the congestion reporting key of data field 1303.

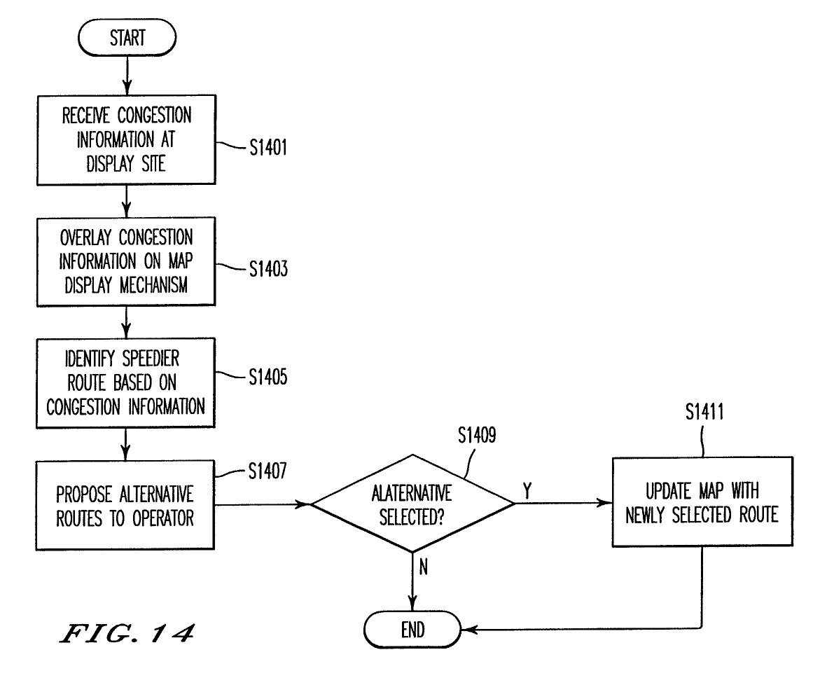

FIG. 14 is a flowchart of a method employed by a message traffic reporting service that may be employed within a particular vehicle of a subscriber. The process begins in step S1401 where the congestion message is received at a particular display site such as in a subscriber's vehicle. The process then proceeds to step S1403 where a map showing the particular location around the subscriber is overlaid with the congestion information on the travel route for that subscriber. The process then proceeds to step S1405 where the processor at the subscriber terminal (which could be a general purpose computer) such as that shown in FIG. 11 for example identifies a speedier route for the subscriber to follow based on the congestion information previously reported by way of the imaging satellite system. The process then proceeds to step S1407 where selected alternatives are proposed to the operator of the vehicle. The process then proceeds to step S1409 where an inquiry is made regarding whether the operator selected an alternative route. If the response to the inquiry is affirmative, the process proceeds to step S1411 where the display is updated with a revised map, showing the newly selected route, and then the process ends.

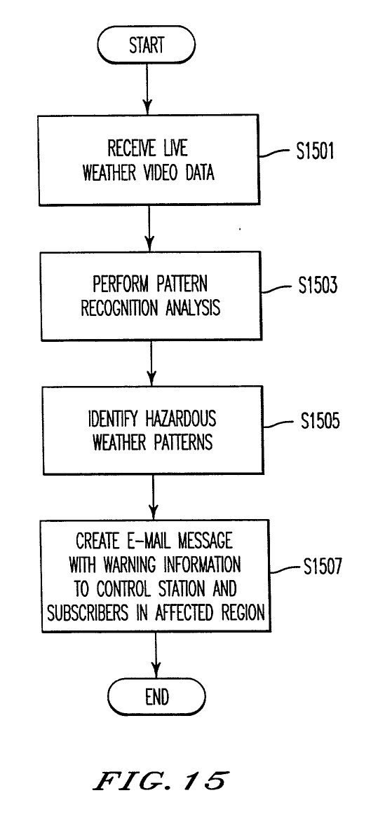

FIG. 15 is a flowchart of a method for producing an e-mail weather warning service for subscribers who have been identified as being located in certain geographic areas and weather events affecting that area are presently being observed. The process begins in step S1501, where the service station, such as ground station 308 (FIG. 3) receives live optical weather data from the imaging satellite. The process then proceeds to step S1503 where the weather pattern data is compared against prerecorded weather patterns of particular events (such as what might be performed with the pattern recognition mechanism 935 of FIG. 4) so that certain weather patterns may be detected. The process then proceeds to step S1505 where hazardous weather patterns are then predicted based on the results of the pattern recognition analysis. Subsequently, the process proceeds to step S1507, where an e-mail message is produced and distributed to subscribers in the area in which the hazardous weather pattern was determined to exist in step S1505. Furthermore the e-mail message is sent to control station and subscribers so that corrective action may be taken and safety precautions may be taken as well. Furthermore, the e-mail message may be sent to media crews so that reports and perspective news reporting may occur for reporting on those particular weather patterns.

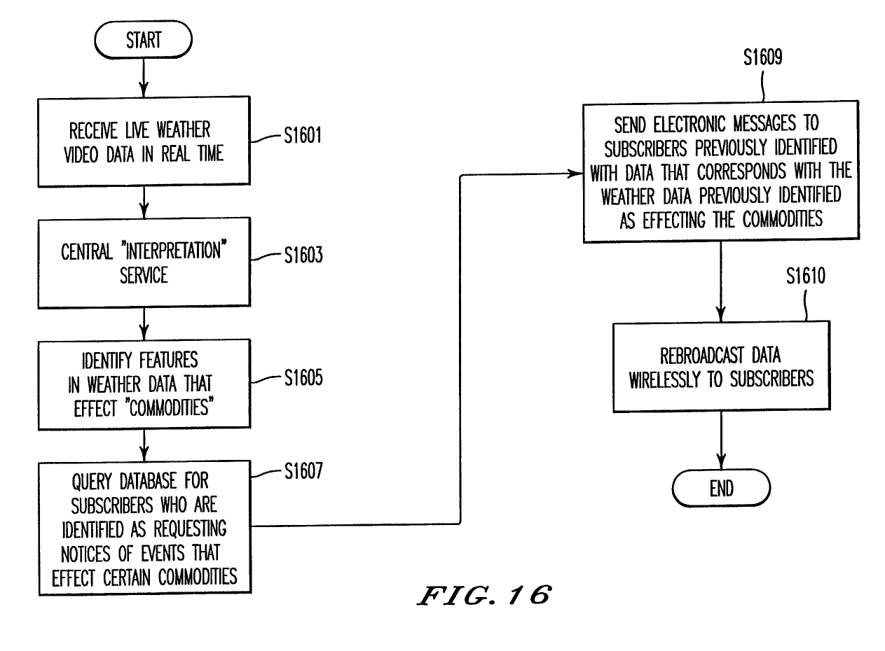

FIG. 16 is a flowchart describing a method according to the present invention in which data collected by satellite 300 or 314 (FIG. 3) is distributed to an “interpretation” service for providing a “data feed” to a commodity trading service. The process begins in step S1601 where the live weather video data is received in real-time. The data is interpreted in step S1603 through a central interpretation service. The central interpretation service includes sector-by-sector (geographically) pattern recognition software that recognizes patterns of cloud activity, lightening flashes, light and colors in direct images to ascertain the features of weather activity within a particular sector. For example, in a sector an unexpected thunderstorm may occur over a particular crop of grain, thus given rise to the likelihood that a larger than expected percentage of the grain would be lost.

When such an alert is identified in step S1605, the central interpretation service queries a database for particular subscribers who have requested information regarding activity within that particular sector (which in this case would relate to the particular yield of a grain crop). When the subscribers have been identified in the database in step S1607, the process proceeds to step S1609 where those particular subscribers are notified of the weather-related data that effects the present price of that particular commodity. Subscribers may be notified by e-mail, a pager message, or other type of wireless or wired communication message. This message may be a wired message transmitted to a particular location and then broadcast through a wireless mechanism (alternatively through a wired network) so that traders on the commodity floor may receive the data and make real-time assessments and trades based on this data. Thus, rebroadcasting the data wirelessly to the subscribers in a local area such as in step S1610 is one optional mechanism for distributing the data according to the present invention. Subsequently, the process ends.

Using the method according to FIG. 16 enables traders of commodities (such as in future markets) to trade actively and efficiently based on data that is publically available, but distributed in a particularly efficient and effective manner.

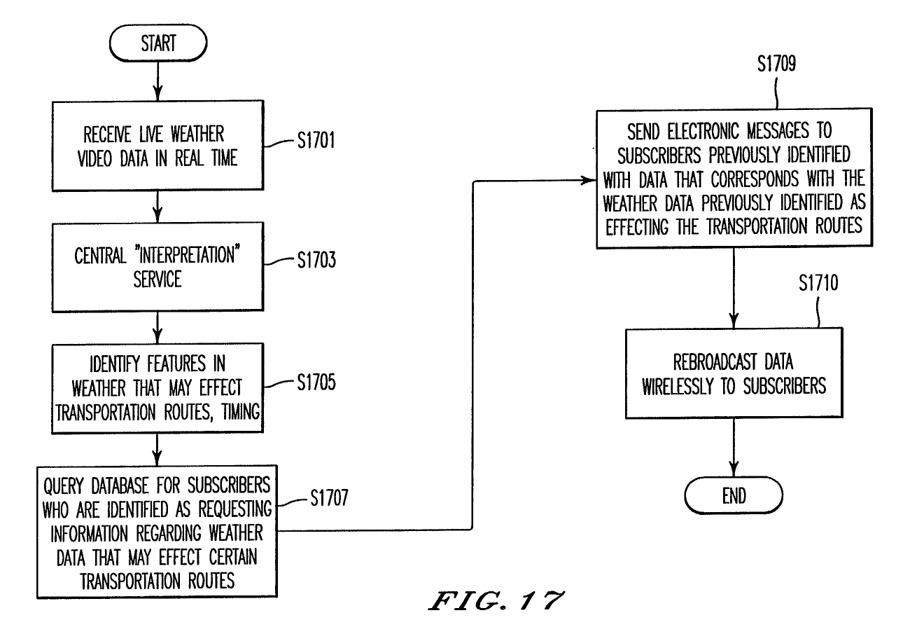

FIG. 17 is a flowchart describing a process for notifying particular subscribers regarding particular weather events observable from geostationary orbit according to the present invention, may effect in some way transportation routes. The process begins in step S1701 where the data is received and then in step S1703 the data is interpreted through a central interpretation service. The central interpretation service will observe particular transportation routes, as requested by subscribers. The process then proceeds to step S1705 where features in the weather data that may effect particular transportation routes (or other effects such as traffic jams) are characterized. When a particular grid element (i.e., portion of an observed geographical area) is detected as having a particular problem, the process proceeds to step S1707 where a query is made in the database for subscribers who have requested to be notified regarding events that may effect particular transportation routes.

Once the particular subscribers are identified, the process proceeds to step S1707 where an electronic message is sent in step S1709 to the subscribers. In reply, the subscribers may take affirmative action in rerouting existing assets in the field (such as truck, for example, on a particular highway) or may opt not to dispatch a garaged vehicle at that time. The process may optionally include a step S1710 where the data is broadcast wirelessly directly to the vehicle that is predicted as encountering an impeded transportation route momentarily. Subsequently the process ends.

This transportation service may be employed for the shipping industry (trucks as well as ocean cargo ships). In this way, the transportation service would be able to operate cost effectively by deploying its assets for the area covered by the respective shipping fleet. Similarly, aside from cargo shipping, the data may also be made available for the airline industry where both airport as well as particular airline services may use the data to reroute traffic to the least congested, least disruptive routes. One advantage with this approach is the airplanes will have the opportunity to follow routes that avoid weather-disturbed geographic areas (thus avoiding turbulence) and also avoiding annoying delays in airports when weather-related delays are present.

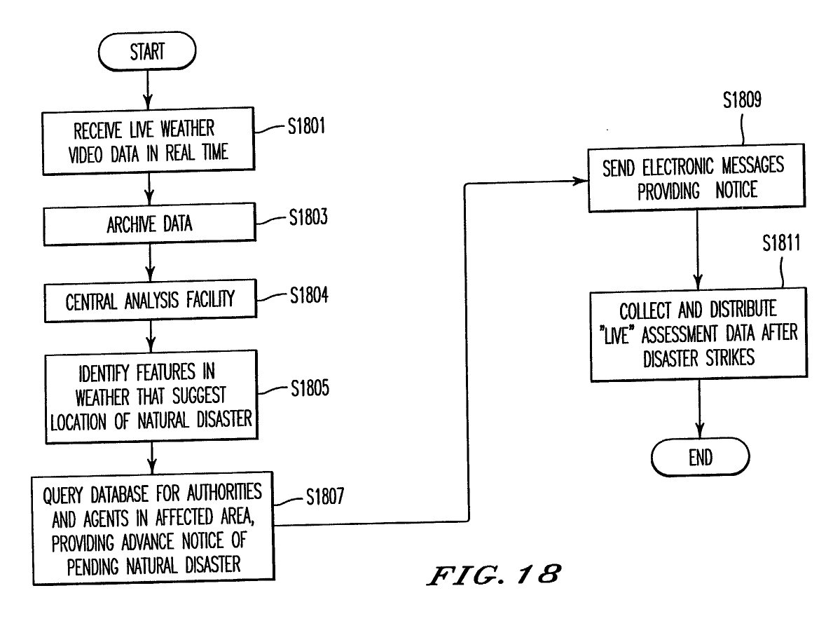

FIG. 18 is a flowchart of a process according to the present invention where weather data is received in step S1801 and then archived in step S1803. In parallel with the archival of the data (although processing may be done in serial fashion as well), a central analysis facility performs an analysis on the data in step S1804. The central analysis facility identifies different geographical regions that may be adversely affected by the natural disasters. One example is a tornado prediction system. When a tornado (or other event) is present, the central analysis facility will be able to specifically identify in real-time those particular natural disasters and then identify from a database query in step S1807 local authorities as well as agents in the area to provide advanced notice for the insured.

The present inventors have observed that one of the deficiencies with existing systems is that because the potential movement of a dangerous weather pattern is broadly predicted over large geographic ranges, many people become accustomed to not believing that the natural disaster will actually effect them. However, part of the reason for this “unreliable” information is that it is difficult to predict from time discontinuous images where the intensity of particular weather related activity will occur. In contrast, the present invention is able to actively track dangerous weather events so that individuals will be given “specific notice” that not only is a natural disaster present within their location, but it also may very likely have an impact on them. Accordingly, people will have advance notice to take extra safe precaution since the likelihood of them experiencing the dangerous weather events is much more likely than with traditional notification systems.

As a consequence, insurance companies will benefit by having individuals take sufficient precautionary measures to avoid injury to themselves or their property, thereby lowering insurance payouts. Subsequently, the process proceeds to step S1811 where assessment data after the natural disaster is collected and then distributed. The data is distributed to insurance appraisers and the like so that specific and quick action may be taken after a particular natural disaster event.

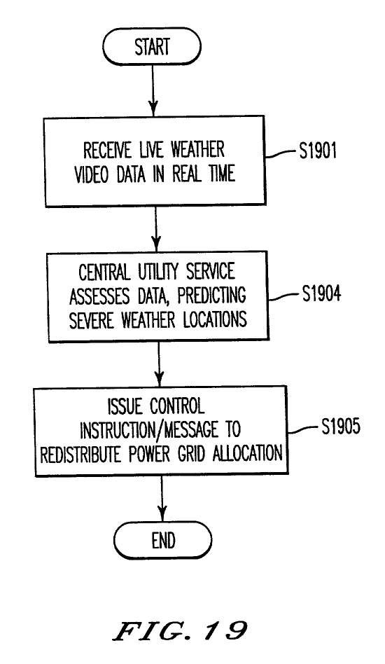

FIG. 19 is a process showing how particular public utilities may reallocate resources to account for weather related events. The process beings in step S1901 where the data is received in real-time. Subsequently the process proceeds to step S1904 where an essential utility service assesses the data and predicts where severe weather locations will be within the area serviced by that particular utility service. Once the areas are identified, the process proceeds to step S1905 where that particular utility exercises control (perhaps manually or automatically through an electronically distributed message). By exerting control by dispatching instructions and messages to redistribute power within the grid (with an electric utility embodiment) the central utility service is able to shift loads for power output depending on the advent of severe weather in particular regions. In this way, the utility companies use the most recently available weather data to cost efficiently load the utility systems during severe weather. Subsequently the process ends.

Another embodiment of the present invention is that predictive weather models are employed to include time “T” as a real-time parameter within the model. Typically such models operate on a frame-by-frame basis with disjoint, time discontinuous data. However, by employing the present invention, the equivalent of real-time data may be employed within the weather model so as to provide greater reliability with regard to rate of change information within the predictive model.

In another embodiment, the computer (or processor) employed in the ground terminal 308 is configured to receive NEXRAD and NOAA Doppler radar data for combination with the high temporal, high spatial resolution imagery data provided by the geostationary satellite according to the present invention. The combination of data streams mutually enhances the potential accuracy of weather forecast services (such as NOAA's National Weather Service “nowcast” service) than if the information from the two data sources were not combined. NEXRAD data is available for use either in raw form (for subsequent processing by an end user) or in image form. In one embodiment the data is received through the NEXRAD Information Dissemination Service, which supplies the data to the ground terminal 308 by way of the Internet. Alternatively, end users directly receive the NEXRAD data and high temporal, high spatial resolution imagery data provided by the geostationary satellite according to the present invention through radio communication.

When received directly, a software based process executed by a processor in an end-user's equipment (which may be the weather forecasting service's equipment) fuses the two data streams. The combined data enables the creation of a composite image having the attributes of data associated with the radar data, with the high temporal, high spatial resolution imagery data provided by the present invention.

The data streams may be combined in a variety of ways. In a dynamic graphics embodiment, the radar data is used to present a weather pattern image of a relatively large geographic region, while a real-time high resolution image of a portion of an even larger geographic region is provided by the geostationary satellite according to the present invention. In this case, the higher resolution NEXRAD portion appears as a “focus spot” in the larger AstroVision satellite visual image, where the RADAR resolution in the focus spot is much greater than that of the remainder of the visual image. Weather reporting and forecasting agencies would then have the benefit of observing both the larger weather patterns, as well as specific, high temporal, high spatial resolution images when making weather forecasts. Alternatively, the main image presented to the operator is provided by the even coarser resolution data in a full disk view from the geostationary satellite, while specific spot images are provided by the radar data.

In one operational context, the operator dispatches weather warning messages to subscribers in regions that are exposed particular weather events. The equipment employed by the operator includes a processor having a graphical user interface (which may be a web browser that interacts with a web page) that enables the operator to selected other regions to which to direct the focus spot. In response to the operator identifying a region in which to direct the focus spot, the processor dispatches a command to the ground terminal 308 to request that the satellite's optics be repositioned to cover the newly selected focus spot.

The data may also be fused in the context of being presented in a graphics format in separate sections of a display. In this way, an operator may view the radar image in one portion of the display, while also viewing the high resolution data in a second part of the display. This “picture in a picture” embodiment optionally includes a control feature where the operator may select different portions of the Earth's surface to display. Alternatively, the two images are displayed side-by-side in different displays. In this configuration, an operator can quickly inspect both the larger sector of Earth's surface represented by the NEXRAD-enabled image (for example), and still be able to observe the high temporal, high spatial resolution imagery data available according to the present invention.

Data made available according to the present invention may also supplement, or be fused with, data offered by the Emergency Managers Weather Information Network, which is a service that allows users to obtain weather forecasts, warnings, and other information directly from the National Weather Service (NWS) in almost real time. EMWIN is intended to be used primarily by emergency managers and public safety officials who need timely weather information to make critical decisions. However, operators having personal computers may be EMWIN users, and thus may also use the personal computer (or other time of processing device having a display) to simultaneously display the high temporal, high spatial resolution imagery data available according to the present invention. Alternatively, the EMWIN itself, or other weather reporting agencies such as NOAA's National Weather Service, may employ the data made available by the present invention to enhance the accuracy of forecasting and “nowcasting” weather prediction services.

The mechanisms and processes set forth in the present description may be implemented using a conventional general purpose microprocessor(s) programmed according to the teachings of the present specification, as will be appreciated to those skilled in the relevant arts. Appropriate software coding can readily be prepared by skilled programmers based on the teachings of the present disclosure, as will also be apparent to those skilled in the relevant arts.

The present invention thus also includes a computer-based product that may be hosted on a storage medium and include instructions that can be used to program a computer to perform a process in accordance with the present invention. This storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

As an example, the present information collects the real-time data from geostationary orbit and distributes the data to subscribers in various forms. In one embodiment, the data is distributed through a terrestrial information servicing center to subscribers with wireless devices such as cellular telephones (including i-mode phones), PCS communication devices, palm-top devices (e.g., PALM IV), laptop computers, pagers, wireless navigation devices, personal digital assistants, and the like. The data may be distributed continuously, or after the information servicing center determines that an event has occurred that is of potential interest to the subscriber and then sends a messaging alert to that subscriber, conveying the relevant data to the subscriber. The messaging alert may include a text message, video information, audio information, or event a signal that indicates to the remote computer (e.g., a wireless device) to sound an audible alarm. Furthermore, the present invention employs a web-server to serve active-content web pages to subscribers who connect to the web pages through the Internet. One example is where the web-server downloads an applet, Java script or other executable code to the subscriber for actively updating the data provided by the web-server. In this way, the subscriber is kept abreast of relevant weather-related events that are of interest to the subscriber.

Obviously, numerous modifications and variations of the present invention are possible in light of the above teachings. It is therefore to be understood that within the scope of the appended claims, the invention may be practiced otherwise than as specifically described herein.

1. An imaging satellite configured to be placed in geostationary orbit, comprising:
an image sensor configured to be positioned toward Earth when in geostationary orbit and configured to produce data of a series of images of at least a portion of a surface of the Earth; and
a transmitter configured to transmit the data to a remote location so that said series of images may be viewed in real-time at said remote location, wherein
each image of said series of images having a hyper-spectral resolution of 100 m or better.

2. The imaging satellite of claim 1, wherein:
said image sensor includes a charge coupled device having at least 1024×1024 elements.

3. The imaging satellite of claim 2, wherein:
said charge coupled device having at least 2048×2048 elements.

4. The imaging satellite of claim 3, wherein:
said charge coupled device having at least 4096×4096 elements.

5. The imaging satellite of claim 4, wherein:
respective of said images having respective resolutions that correspond with an image at nadir having a 10 m or better resolution when the satellite is placed in geostationary orbit.

6. The imaging satellite of claim 1, further comprising:
a scan system configured to change a relative position of the image sensor with regard to the surface of the Earth so that the image sensor perceives different portions of the Earth's surface when producing the data of the series of images.

7. The imaging satellite of claim 6 further comprising:
an optics subsystem configured to adjust a field of view observed by said image sensor when producing said data of the series of images.

8. The imaging satellite of claim 6, wherein:
said scan system includes a motor-actuated mirror configured to adjust an optics path that impinges on said image sensor by adjusting a relative position of the motor-actuated mirror with respect to the image sensor.

9. The imaging satellite of claim 6, wherein:
said scan system includes a control mechanism configured to control an amount of spin imparted by a momentum wheel on said satellite so as to impart a relative rotation of the satellite with respect to the Earth and cause an optical path of said image sensor to change with respect to a predetermined spot on Earth.

10. The imaging satellite of claim 6, wherein:
said scan system includes a controller that is configured to adjust a scanning operation of said scan system to cause s aid image sensor to produce said series of images according to a step-stare pattern.

11. The imaging satellite of claim 6, further comprising:
a software reconfigurable processor that is configured control said scan system to perform at least one of a full scan raster operation, perform a geo-reference tracking operation, and dwell at a predetermined portion on the surface of the Earth for a predetermined dwell time.

12. The imaging satellite of claim 1, wherein:
said transmitter includes a data compression mechanism configured to compress the data before transmitting the data to said remote location.

13. The imaging satellite of claim 1, wherein:
said image sensor being configured to produce the images of the surface of the Earth, at night.

14. The imaging satellite of claim 1, wherein:
said transmitter being configured to transmit said data to another satellite via a cross-link.

15. The imaging satellite of claim 1, wherein:
said transmitter being configured to transmit said data directly to a ground terminal.

16. The imaging satellite of claim 1, wherein:
said transmitter being configured to transmit said data to said remote location by way of a terrestrial communication network.

17. The imaging satellite of claim 1, wherein:
said transmitter being configured to transmit said data to a network node configured to relay said data to said remote location by way of an Internet.

18. A constellation of at least four imaging satellites in geostationary orbit, each satellite comprising:
an image sensor positioned toward Earth and configured to produce data of a series of images of at least a portion of a surface of the Earth; and
a transmitter configured to transmit the data to a remote location so that said series of images may be viewed in real-time at said remote location, wherein
each image of said series of images having a hyper-spatial resolution equating to 10 m or better if taken at nadir, wherein each of said at least four satellites being configured to communicate with ground facilities located within line of sight of respective of the at least four satellites.

19. The constellation of claim 18, further comprising:
at least one communication satellite configured to receive and route the data to the remote location by way of a ground-based teleport.

20. A method for capturing and distributing real-time image data from geostationary orbit, comprising steps of:
forming a series of images of at least a portion of a surface of Earth, including
forming the series of images at a frame rate of 1 second per frame or faster, and
forming the series of images with respective resolutions equating to at least 500 m if taken at nadir;
producing a stream of data representative of the series of images; and
transmitting the data to a remote location.

21. The method of claim 20, further comprising:
a step of receiving the data at the remote location and producing the images from the data for real-time viewing.

22. The method of claim 20, wherein:
said step of forming a series of images includes scanning an image sensor over a field of view that includes a predetermined portion of the surface of the Earth so as to produce the series of images at different locations on the surface of the Earth.

23. The method of claim 22, wherein:
said step of forming a series of images includes adjusting a field of view of the image sensor by adjusting an optical path to the image sensor.

24. The method of claim 23, wherein:
said scanning step includes adjusting a relative position of a mirror with respect to said image sensor to change an optical path leading to said image sensor.

25. The method of claim 23, wherein:
said step of scanning includes adjusting a speed of a satellite-based momentum wheel.

26. The method of claim 23, wherein:
said scanning step includes scanning said image sensor to form a step-stare series of images.

27. The method of claim 20, wherein:
said step of forming a series of images includes controlling an image sensor to perform at least one of a full scan raster operation, a geo reference tracking operation, and a dwell point adjustment operation.

28. The method of claim 20, wherein:
said transmitting step includes compressing the data.

29. The method of claim 20, wherein:
said step of forming a series of images, includes forming the series of images at night.

30. The method of claim 20, wherein:
said transmitting step includes transmitting the data to another satellite via a cross-link.

31. The method of claim 20, wherein:
said transmitting step includes transmitting said data directly to a ground terminal.

32. The method of claim 20, wherein:
said receiving step includes receiving the data at a remote location by way of a terrestrial communication network.

33. The method of claim 22, wherein:
said receiving step includes receiving the data through an Internet, as said terrestrial communication network.

34. An imaging satellite configured to be placed in geostationary orbit, comprising:
means for forming a series of images of at least a portion of a surface of Earth, including
means for forming the series of images at a frame rate that is one second or less,
means for forming the series of images with respective resolutions equating to at least 500 m if taken at nadir;
means for producing a stream of data that represents the series of images; and
means for transmitting the data to a remote location.

35. The imaging satellite of claim 1, wherein:
said image sensor being configured to produce said data of a series of color images.

36. The method of claim 20, wherein:
said step of forming the series of images comprises forming said series of images in color.

37. The imaging satellite of claim 34, wherein:
said means for forming a series of images comprises means for forming color images.

38. An imaging satellite system having a hyper-resolution capability of 100 m or less, comprising:
an image sensor configured to be positioned on a platform for use in geostationary orbit, said image sensor being positioned towards earth and configured to produce data of a series of images of at least a portion of a surface of the earth; and
a transmitter configured to transmit the data to a remote location so that said series of images may be viewed at said remote location; and
a traffic congestion detection mechanism for determining an amount of traffic present on a particular roadway as observed from space and an indicator of said traffic being included in said traffic message.

39. The system of claim 38, further comprising a map display system on which congestion information is displayed regarding traffic congestion for particular roadways located on said map.

40. A maritime weather reporting system, comprising:
an image sensor positioned toward Earth and configured to produce data of a series of images of at least a portion of a surface of the Earth; and
a transmitter configured to transmit the data to a remote location so that said series of images may be viewed in real-time at said remote location, wherein
each image of said series of images having a resolution of 100 m or less, wherein said remote location being a maritime vessel configured to receive by way of wireless communication weather pattern information provided by optical information collected from said image sensor.

41. A weather event reporting system, comprising:
an image sensor positioned in geostationary satellite positioned toward Earth and configured to produce data of a series of images of at least a portion of a surface of the Earth; and
a transmitter configured to transmit the data to a remote location so that said series of images may be viewed in real-time at said remote location, wherein
each image of said series of images having a resolution that equates to at least 500 m or better resolution at nadir, wherein said transmitter is configured to transmit the data to a remote location, and said remote location being configured to produce an e-mail message to be sent to a subscriber reporting a presence of a predetermined weather pattern known to exist at said remote location as observed by said image sensor.

42. A method for providing commodity-value related data to a commodity trader, comprising steps of:
receiving from a transmitter in geostationary orbit real-time image data of a predetermined portion of a surface of the Earth and cloud activity above the predetermined portion, a resolution of said image data being at least 500 m or better resolution at nadir;
analyzing said real-time image data and identifying a feature in said real-time image data indicative of an event that affects a present or future value of a commodity;
preparing a message alert regarding said present or future value of said commodity and identifying said commodity; and
sending said message alert to a remote computer configured to present said message alert to the commodity trader.

43. The method of claim 42, wherein:
said identifying step includes identifying as said event at least one of a thunderstorm and a tornado.

44. The method of claim 42, wherein:
said commodity being a food commodity.

45. The method of claim 42, wherein:
said commodity being a crop of grain.

46. The method of claim 42, wherein:
said preparing step includes inserting a written description of the event in said message alert.

47. The method of claim 42, wherein:
said preparing step includes including image data of the event in said message alert.

48. The method of claim 42, wherein:
said preparing step includes inserting an indication of a likelihood of said event affecting said present or future value of said commodity.

49. The method of claim 48, wherein:
said preparing step includes inserting in said message alert a suggested change in present or future value based on said likelihood.

50. The method of claim 42, wherein:
said sending step includes sending said message alert in at least one of an e-mail message, a pager message and a web site posting.

51. The method of claim 50, wherein:
said web site posting includes actively updating a web browser screen by execution of at least one of an applet and Java script.

52. The method of claim 42, further comprising a step of:
presenting said message alert at said remote computer as at least one of a text message, a video image, and an audible alert.

53. The method of claim 42, wherein:
said remote computer being at least one of a portable computer, a display board configured to be viewed by multiple traders, a wireless telephony device, and a personal digital assistant.

54. The method of claim 42, further comprising a step of:
querying a database and identifying message addresses of subscribers who requested to be informed when the event occurs, wherein
said sending step includes sending said message alert to message addresses of said subscribers identified in said querying step.

55. A computer-implemented analysis apparatus for providing commodity-value related data to a commodity trader, comprising:
a receiver configured to receive from a transmitter in geostationary orbit real-time image data of a predetermined portion of a surface of the Earth and cloud activity above the predetermined portion, said image data having a resolution that equates to 500 m or better resolution if taken at nadir;
a processor configured to analyze said real-time image data and identify a feature in said real-time image data indicative of an event that affects a present or future value of a commodity, said processor being programmed to prepare a message alert regarding said present or future value of said commodity and identifying said commodity in said message alert; and
an output terminal configured to output to a communication channel said message alert to a remote computer configured to present said message alert to the commodity trader.

56. The analysis apparatus of claim 55, wherein:
said processor being configured to identify as said event at least one of a thunderstorm and a tornado.

57. The analysis apparatus of claim 55, wherein:
said output terminal being configured to send said message alert in at least one of an Internet e-mail message, a voice message and a web site posting.

58. The analysis apparatus of claim 57, wherein:
said processor being configured to implement a web server that downloads at least one of a Java applet, and a Java script so as to dynamically update a display of a web browser implemented on said remote computer.

59. The analysis apparatus of claim 58, further comprising:
a database encoded with message addresses of subscribers to be informed when the event occurs; wherein
said processor being configured to query said database and determine to which message addresses to send the message alert when the event occurs.

60. A method for managing a transportation fleet, comprising steps of:
receiving from a transmitter in geostationary orbit real-time image data of a predetermined portion of a surface of the Earth and cloud activity above the predetermined portion, said image data having a resolution that equates to 500 m or better resolution if taken at nadir;
analyzing said real-time image data and identifying a feature in said real-time image data indicative of an event that affects an ease of vehicle passability of a predetermined transportation route in said predetermined portion;
preparing a transportation route direction message with an instruction to follow an alternate transportation route; and
sending a transportation route direction message to a remote computer configured to present said transportation route direction message to a vehicle affected by the event.

61. The method of claim 60, wherein:
said identifying step includes identifying as said event at least one of a thunderstorm and a tornado.

62. The method of claim 60, wherein:
said sending step includes sending said transportation route direction message in at least one of an e-mail message, a voice message and a web site posting.

63. The method of claim 62, wherein:
said web site posting includes actively updating a web browser screen by execution of at least one of an applet, and a Java script.

64. The method of claim 60, further comprising a step of:
presenting said transportation route direction message at said remote computer as at least one of a text message, a video image, and an audible alert.

65. The method of claim 60, wherein:
said remote computer being at least one of a portable computer, a navigation device mounted in said vehicle, a wireless telephony device, and a personal digital assistant.

66. The method of claim 60, further comprising steps of:
querying a database and identifying a message addresses of vehicles having travel routes that include at least a portion of said predetermined transportation route, wherein
said sending step includes sending said transportation route direction message to message addresses of said vehicles identified in said querying step.

67. The method of claim 60, wherein:
said predetermined transportation route being at least one of a ground route, an air route, and a water route.

68. The method of claim 60, wherein:
said vehicle being at least one of a truck, a boat, and an airplane.

69. A computer-implemented analysis apparatus for managing a transportation fleet, comprising:
a receiver configured to receive from a transmitter in geostationary orbit real-time image data of a predetermined portion of a surface of the Earth and cloud activity above the predetermined portion, said image data having a resolution that equates to 500 m or better resolution if taken at nadir;
a processor configured to analyze said real-time image data and identify a feature in said real-time image data indicative of an event that affects an ease of possibility of a predetermined transportation route in said predetermined portion, said processor being programmed to prepare a transportation route direction message with an instruction to follow an alternate transportation route; and
an output terminal configured to output to a communication channel said transportation route direction message to a remote computer configured to present said transportation route direction message to a vehicle affected by the event.

70. The analysis apparatus of claim 69, wherein:
said processor being configured to identify as said event at least one of a thunderstorm and a tornado.

71. The analysis apparatus of claim 69, wherein:
said output terminal being configured to send said transportation route direction message in at least one of an Internet e-mail message, a voice message and a web site posting.

72. The analysis apparatus of claim 71, wherein:
said processor being configured to implement a web server that downloads at least one of an applet, and a Java script so as to dynamically update a display of a web browser implemented on said remote computer.

73. The analysis apparatus of claim 69, further comprising:
a database encoded with message addresses of vehicles having travel routes that include at least a portion of said predetermined transportation route, wherein
said processor being configured to query said database so as to determine to which message addresses to send the transportation route direction message.

74. A method for managing a public utility, comprising steps of:
receiving from a transmitter in geostationary orbit real-time image data of a predetermined portion of a surface of the Earth and cloud activity above the predetermined portion, said image data having a resolution that equates to 500 m or better resolution if taken at nadir;
analyzing said real-time image data and identifying a feature in said real-time image data indicative of an event that affects a demand on a predetermined service area;
preparing an asset reallocation message to shift an operational load from assets normally servicing said predetermined service area to other assets of the public utility; and
sending said asset reallocation message to a control computer configured to at least partially shift an operational load from the assets normally servicing the predetermined service area to the other assets.

75. The method of claim 74, wherein:
said identifying step includes identifying as said event at least one of a thunderstorm and a tornado.

76. The method of claim 74, wherein:
said sending step includes sending said asset reallocation message in at least one of an e-mail message, a direct control signal, a voice message and a web site posting.

77. The method of claim 76, wherein:
said web site posting includes actively updating a web browser screen by execution of at least one of an applet, and a Java script.

78. The method of claim 76, wherein:
said assets being electric power assets.

79. A computer-implemented public utility asset allocation apparatus, comprising:
a receiver configured to receive from a transmitter in geostationary orbit real-time image data of a predetermined portion of a surface of the Earth and cloud activity above the predetermined portion, said image data having a resolution that equates to 500 m or better resolution if taken at nadir;
a processor configured to analyze said real-time image data and identify a feature in said real-time image data indicative of an event that affects an amount of loading on a predetermined sector of public utility assets, said processor being programmed to prepare an asset reallocation message with an instruction to reallocate an expected change in load on said sector based on an occurrence of said event; and
an output terminal configured to send said asset reallocation message to a control computer configured to at least partially shift an operational load from the assets in the sector normally servicing the predetermined service area to other public utility assets.

80. The apparatus of claim 79, wherein:
said processor being configured to identify as said event at least one of a thunderstorm and a tornado.

81. The apparatus of claim 79, wherein:
said assets being electric utility assets.

82. A method for modeling weather patterns, comprising steps of:
receiving from a transmitter in geostationary orbit real-time image data of a predetermined portion of a surface of the Earth taken at sub-minute intervals and cloud activity above the predetermined portion, said image data having a resolution that equates to 500 m or better resolution if taken at nadir;
analyzing said real-time image data using time as a parameter having sub-minute resolution between adjacent images produced from said real-time image data;
identifying a feature in said real-time image data indicative of a weather-related event to be tracked;
saving respective locations of said feature for each sub-minute interval;
predicting a movement of said feature by projection of future positions of said feature by projection of a temporal pattern of past positions of said feature saved in said saving step.

83. The method of claim 82, wherein:
said event being at least one of a thunderstorm and a tornado.

84. A method for mitigating weather-related damage and injury by issuing a specific warning message, comprising steps of:
receiving from a transmitter in geostationary orbit real-time image data of a predetermined portion of a surface of the Earth and cloud activity above the predetermined portion, said image data having a resolution that equates to 500 m or better resolution if taken at nadir;
analyzing said real-time image data and identifying a feature in said real-time image data indicative of a serious weather event to effect a warning region within said predetermined portion of the surface of the Earth;
querying a database to identify an address of a subscriber having property located within said warning region;
preparing a message alert addressed to said subscriber; and
sending said message alert to said subscriber so as to enable the subscriber can take affirmative self-security steps and steps to secure property of the subscriber.

85. The method of claim 84, wherein:
said identifying step includes identifying as said serious weather event at least one of a thunderstorm and a tornado.

86. The method of claim 84, wherein:
said preparing step includes inserting a written description of the event in said message alert.

87. The method of claim 84, wherein:
said preparing step includes including image data showing the event in said message alert.

88. The method of claim 84, wherein:
said sending step includes sending said message alert in at least one of an e-mail message, a voice message and a web site posting.

89. The method of claim 88, wherein:
said web site posting includes actively updating a web browser screen by execution of at least one of an applet, and a Java script.

90. A computer-implemented analysis apparatus for mitigating weather-related damage and injury by issuing a specific warning message, comprising:
a receiver configured to receive from a transmitter in geostationary orbit real-time image data of a predetermined portion of a surface of the Earth and cloud activity above the predetermined portion, said image data having a resolution that equates to 500 m or better resolution if taken at nadir;
a computer readable medium configured to hold a database of subscriber information, said database including an address and a geographic region for a subscriber;
a processor configured to analyze said real-time image data and identify a feature in said real-time image data indicative of a serious weather event to effect a warning region within said predetermined portion of the surface of the Earth, said processor being programmed to query the database and preparing a message alert addressed to said particular subscriber if said warning region coincides with said geographic region for said subscriber; and
an output terminal configured to output to a communication channel said message alert to a remote computer configured to present said message alert to the subscriber.

91. The analysis apparatus of claim 90, wherein:
said processor being configured to identify as said severe-weather event at least one of a thunderstorm and a tornado.

92. The analysis apparatus of claim 90, wherein:
said output terminal being configured to send said message alert in at least one of an Internet e-mail message, a voice message and a web site posting.

93. The analysis apparatus of claim 92, wherein:
said processor being configured to implement a web server that downloads at least one of an applet, and a Java script so as to dynamically update a display of a web browser implemented on said remote computer.

94. A method for assessing weather-related damage, comprising steps of:
receiving from a transmitter in geostationary orbit real-time image data of man-made and natural features in a predetermined portion of a surface of Earth, said image data having a resolution that equates to 500 m or better resolution if taken at nadir;
analyzing said real-time image data and identifying a change in said features after a serious weather-related event relative to before an occurrence of said serious weather-related event;
preparing an assessment message configured to convey to an assessment agency said change in said features; and
sending said assessment message to said assessment agency.

95. The method of claim 94, wherein:
said assessment agency being an insurance company.

96. The method of claim 95, wherein:
said features being at least one of a residence of a property owner.

97. The method of claim 94, wherein:
said assessment agency being an insurance appraiser.

98. A weather-related damage assessment apparatus, comprising:
means for receiving from a transmitter in geostationary orbit real-time image data of man-made and natural features in a predetermined portion of a surface of the Earth, said image data having a resolution that equates to 500 m or better resolution if taken at nadir;
means for analyzing said real-time image data and means for identifying a change in said features after a serious weather-related event relative to before an occurrence of said serious weather-related event;
means for preparing an assessment message configured to convey an indication of said change in said features; and
means for sending said assessment message to said assessment agency.
